(19) United States
(12) Patent Application Publication
(10) Pub. No.: US 2024/0414492 A1
(43) Pub. Date: Dec. 12, 2024

(54) MAPPING OF ENVIROMENTAL AUDIO RESPONSE ON MIXED REALITY DEVICE

(71) Applicant: Magic Leap, Inc., Plantation, FL (US)

(72) Inventors: Mark Brandon HERTENSTEINER, San Jose, CA (US); Justin Dan MATHEW, Fort Lauderdale, FL (US); Remi Samuel AUDFRAY, San Francisco, CA (US); Jean-Marc JOT, Aptos, CA (US); Benjamin Thomas VONDERSAAR, Indianapolis, IN (US); Michael Z. LAND, Mill Valley, CA (US)

(21) Appl. No.: 18/703,302

(22) PCT Filed: Oct. 18, 2022
(86) PCT No.: PCT/US2022/078316

§ 371 Date: Apr. 19, 2024

Related U.S. Application Data
(60) Provisional application No. 63/271,659, filed on Oct. 25, 2021.

(51) Int. Cl. H04S 7/00; G06F 3/16; G06T 19/00; G10L 21/0208

(52) U.S. Cl. CPC H04S 7/303; G06F 3/167; G06T 19/006; G10L 21/0208; H04S 7/305; G10L 2021/02082; H04S 2400/11

(57) ABSTRACT

This disclosure relates in general to augmented reality (AR), mixed reality (MR), or extended reality (XR) environmental mapping. Specifically, this disclosure relates to AR, MR, or XR audio mapping in an AR, MR, or XR environment. In some embodiments, the disclosed systems and methods allow the environment to be mapped based on a recording. In some embodiments, the audio mapping information is associated to voxels located in the environment.

### CROSS-REFERENCE TO RELATED APPLICATIONS

This application claims priority to U.S. Provisional Application No. 63/271,659, filed on Oct. 25, 2021, the contents of which are incorporated by reference herein in their entirety.

### FIELD

This disclosure relates in general to augmented reality (AR), mixed reality (MR), or extended reality (XR) environmental mapping. Specifically, this disclosure relates to AR, IR, or XR audio mapping in an AR, MR, or XR environment.

### BACKGROUND

Sound in a natural setting may be subjected to some amount of reverberation based on the physical environment. Recorded or synthesized sounds to which no reverberation has been added may sound unnatural (e.g., characterized by the non-technical term “dry”) when played over headphones or via other close-delivery system (e.g., via speakers of a wearable head device).

A method for making a sound more natural in an environment—such as in a video game, radio broadcast, film/TV show, or recorded music—is to apply an appropriate amount of artificial reverberation to a dry audio signal. For example, if one seeks to simulate a large hall, an appropriate amount of artificial reverberation would have a longer decay time and a lower gain relative to the direct signal, compared to emulation of a reverberation in a small room.

In cases where artificial reverb is used (e.g., in the instances described above), the space one wishes to acoustically emulate may either be pre-defined or irrelevant to user experience. In the case of video games experiences that may prioritize realism over artistic choice, a pre-designed level or scene will contain dimensions of rooms and spaces (some include acoustically relevant information such as object and surface materials) that are precisely known in advance of build time. In cases of music production or sonic theater, there may be no attempt or goal to synchronize the auditory scene with a visual corollary, and the simulated space provided by reverberation defines the perceived ‘physical’ space in which the piece is experienced. In film and television, reverberation may be used to heighten a sense of a viewer with a shared space of the program material—e.g., in a cathedral or confined within a coffin—but in these instances, that shared space is well understood, well in-advance of sound design. In all these cases, knowledge of the geometry and/or material properties of a physical space may directly inform reverberation parameters to achieve a perceptually congruent result.

In AR, MR, or XR applications, however, no information about a user's physical environment may be presumed or known in advance, and accurate information about the environment is important in deriving realistic audio responses to create an immersive user experience. Such information may be gathered by visual and/or movement sensor measurement (e.g., by sensor of the AR, MR, or XR device), and in some instance, in real time.

It may be desirable to gather information and derive the audio responses (e.g., environmental reverberation) more efficiently, for example, using different capturing components and/or performing at least a part of the analysis offline. It may also be desirable to associate these derivations in an efficient and scalable manner.

### BRIEF SUMMARY

Systems and methods for AR, MR, or XR environmental mapping are disclosed. Specifically, this disclosure relates to audio mapping and association of the mapping in an AR, MR, or XR environment. In some embodiments, the disclosed systems and methods allow the environment to be mapped based on a recording. In some embodiments, the audio mapping information is associated to voxels located in the environment.

In some embodiments, a method comprises: receiving a signal; and determining whether the signal meets a requirement of an analysis.

In some embodiments, the signal comprises an audio signal, and the analysis is associated with an audio mapping of an environment.

In some embodiments, the requirement comprises at least one of minimum signal-to-noise (SNR) constraint, signal duration constraint, collocation constraint, omnidirectional constraint, and impulsive signal constraint.

In some embodiments, determining whether the minimum SNR constraint is met comprises determining whether a signal level exceeds a threshold value.

In some embodiments, the threshold value is a second threshold value above the noise floor.

In some embodiments, the method further comprises tracking the noise floor.

In some embodiments, the method further comprises adjusting the noise floor.

In some embodiments, determining whether the duration constraint is met comprises determining whether a signal level exceeds a threshold value for at least a threshold duration of time.

In some embodiments, determining whether the collocation constraint is met comprises determining whether a source of the signal is within a threshold distance of a location of the receipt of the signal.

In some embodiments, determining whether the collocation constraint is met comprises applying a voice activated detection (VAD) process based on the signal.

In some embodiments, determining whether the omnidirectional constraint is met comprises determining whether a source of the signal comprises an omnidirectional source.

In some embodiments, determining whether the omnidirectional constraint is met comprises determining one or more of a radiation pattern for a source of the signal and an orientation for the source of the signal.

In some embodiments, determining whether the omnidirectional constraint is met comprises applying a VAD process based on the signal.

In some embodiments, determining whether the impulse constraint is met comprises determining whether the signal comprises one or more of an instantaneous signal, an impulse signal, and a transient signal.

In some embodiments, determining whether the impulse constraint is met comprises applying a dual envelope follower based on the signal.

In some embodiments, the method further comprises: determining the signal the impulse constraint is not met; and in accordance with the determination that the impulse constraint is not met: converting the signal into a clean input stream; and comparing the clean input stream with the signal.

In some embodiments, the method further comprises: in accordance with a determination that the analysis requirement is met, performing a below method; and in accordance with a determination that the analysis requirement is not met, forgoing performing a below method.

In some embodiments, the method further comprises smoothing the signal into an RMS envelope.

In some embodiments, the method further comprises line-fitting the RMS envelope.

In some embodiments, the signal comprises a block of samples.

In some embodiments, receiving the signal further comprises detecting the signal via a microphone.

In some embodiments, receiving the signal further comprises receiving the signal from a storage.

In some embodiments, the signal is generated by a user.

In some embodiments, the signal is generated orally by the user.

In some embodiments, the signal is generated non-orally by the user.

In some embodiments, the signal is generated by a device different than a device receiving the signal.

In some embodiments, the method further comprises requesting generation of the signal, wherein the signal generated in response to a request to generate the signal.

In some embodiments, a method comprises: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

In some embodiments, the signal meets an analysis requirement.

In some embodiments, the analysis requirement is at least one of minimum signal-to-noise (SNR) constraint, signal duration constraint, collocation constraint, omnidirectional constraint, and impulsive signal constraint.

In some embodiments, the method further comprises smoothing the signal using an RMS envelope.

In some embodiments, filtering the signal comprises using a FIR non-causal, zero-phase filter.

In some embodiments, filtering the signal comprises using a FIR non-causal quadrature mirror filter (QMF).

In some embodiments, the sub-bands comprises a low frequency sub-band, a mid frequency sub-band, and a high frequency sub-band.

In some embodiments, a number of sub-bands is greater than a number of decay time control points.

In some embodiments, identifying the peak of the signal comprises identifying a local minima of a first derivative of the signal.

In some embodiments, the peak is temporally located before a time of the local minima.

In some embodiments, identifying the peak of the signal comprises identifying a portion of a first derivative of the signal below a threshold value.

In some embodiments, the peak is temporally located before a time of the portion of the first derivative of the signal below the threshold value.

In some embodiments, identifying the decay comprises line-fitting a decaying portion of the signal corresponding to the sub-band.

In some embodiments, the signal corresponding to the sub-band comprises an early reflection portion between the peak and the decay portion.

In some embodiments, the early reflection portion comprises a portion of the signal corresponding to early reflections.

In some embodiments, the method further comprises from the early reflection portion: determining a reflection delay; and determining a reflection gain.

In some embodiments, an end of the decaying portion corresponds to a threshold signal level.

In some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

In some embodiments, the decay times and reverberation gains are combined by line-fitting.

In some embodiments, the decay times and reverberation gains are combined based on weights corresponding to the respective decay times and reverberation gains.

In some embodiments, the method further comprises repeating the method.

In some embodiments, a method comprises: receiving a signal; generating a direct path signal; deconvolving the signal based on the direct path signal; based on said deconvolving: determining a decay time; and determining a reverberation gain.

In some embodiments, a method comprises associating one or more portions of an audio mapping of an environment to a plurality of voxels located in the environment. Each portion comprises an audio response property associated with a location of a respective voxel in the environment.

In some embodiments, the method further comprises: determining a location of a device, a first voxel of the plurality of voxels comprising the location of the device; and presenting, to the device, a sound of the environment based on an audio response property associated with the first voxel.

In some embodiments, the audio response property comprises at least one of reverberation gain, decay time, reflection delay, and reflection gain.

In some embodiments, volumes of the voxels are uniform.

In some embodiments, volumes of the voxels are non-uniform.

In some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

In some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

In some embodiments, the weight is based on a distance between the first voxel and a location of the first signal.

In some embodiments, the weight is based on an age of the audio response property associated with the first voxel.

In some embodiments, the weight is based on a determination of whether the first voxel is associated with a second audio response property, prior to association of the first audio response property.

In some embodiments, the weight is based on a confidence of the audio response property associated with the first voxel.

In some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

In some embodiments, the method further comprises: receiving the first signal at a first time; and receiving the second signal at a second time.

In some embodiments, the method further comprises: receiving, at a first device, the first signal; and receiving, at a second device, the second signal.

In some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

In some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

In some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain.

In some embodiments, the plurality of voxels are associated with metadata, wherein the metadata comprises at least one of first measurement, time stamp, position, and confidence.

In some embodiments, a system comprises: a microphone; and one or more processors configured to execute a method comprising: receiving, via the microphone, a signal; and determining whether the signal meets a requirement of an analysis.

In some embodiments, the signal comprises an audio signal, and the analysis is associated with an audio mapping of an environment.

In some embodiments, the requirement is at least one of minimum signal-to-noise (SNR) constraint, signal duration constraint, collocation constraint, omnidirectional constraint, and impulsive signal constraint.

In some embodiments, determining whether the minimum SNR constraint is met comprises determining whether a signal level exceeds a threshold value.

In some embodiments, the threshold value is a second threshold value above the noise floor.

In some embodiments, the method further comprises tracking the noise floor.

In some embodiments, the method further comprises adjusting the noise floor.

In some embodiments, determining whether the duration constraint is met comprises determining whether a signal level exceeds a threshold value for at least a threshold duration of time.

In some embodiments, determining whether the collocation constraint is met comprises determining whether a source of the signal is within a threshold ddistance of a location of the receipt of the signal.

In some embodiments, determining whether the collocation constraint is met comprises applying a VAD process based on the signal.

In some embodiments, determining whether the omnidirectional constraint is met comprises determining whether a source of the signal comprises an omnidirectional source.

In some embodiments, determining whether the omnidirectional constraint is met comprises determining one or more of a radiation pattern for a source of the signal and an orientation for the source of the signal.

In some embodiments, determining whether the omnidirectional constraint is met comprises applying a VAD process based on the signal.

In some embodiments, determining whether the impulse constraint is met comprises determining whether the signal comprises one or more of an instantaneous signal, an impulse signal, and a transient signal.

In some embodiments, determining whether the impulse constraint is met comprises applying a dual envelope follower based on the signal.

In some embodiments, the method further comprises: determining the impulse constraint is not met; and in accordance with the determination that the impulse constraint is not met: converting the signal into a clean input stream; and comparing the clean input stream with the signal.

In some embodiments, wherein the method further comprises: in accordance with a determination that the analysis requirement is met, performing an above method; and in accordance with a determination that the analysis requirement is not met, forgoing performing an above method.

In some embodiments, the method further comprises smoothing the signal into an RMS envelope.

In some embodiments, the method further comprises line-fitting the RMS envelope.

In some embodiments, the signal comprises a block of samples.

In some embodiments, receiving the signal further comprises detecting the signal via a microphone.

In some embodiments, receiving the signal further comprises receiving the signal from a storage.

In some embodiments, the signal is generated by a user.

In some embodiments, the signal is generated orally by the user.

In some embodiments, the signal is generated non-orally by the user.

In some embodiments, the signal is generated by a device different than a device receiving the signal.

In some embodiments, the method further comprises requesting generation of the signal, wherein the signal generated in response to a request to generate the signal.

In some embodiments, the system further comprises a wearable head device, wherein the wearable head device comprises the microphone.

In some embodiments, a system comprises one or more processors configured to execute a method comprising: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

In some embodiments, the signal meets an analysis requirement.

In some embodiments, the analysis requirement is at least one of minimum signal-to-noise (SNR) constraint, signal duration constraint, collocation constraint, omnidirectional constraint, and impulsive signal constraint.

In some embodiments, the method further comprises smoothing the signal using an RMS envelope.

In some embodiments, filtering the signal comprises using a FIR non-causal, zero-phase filter.

In some embodiments, filtering the signal comprises using a FIR non-causal quadrature mirror filter (QMF).

In some embodiments, the sub-bands comprises a low frequency sub-band, a mid frequency sub-band, and a high frequency sub-band.

In some embodiments, a number of sub-bands is greater than a number of decay time control points.

In some embodiments, identifying the peak of the signal comprises identifying a local minima of a first derivative of the signal.

In some embodiments, the peak is temporally located before a time of the local minima.

In some embodiments, identifying the peak of the signal comprises identifying a portion of a first derivative of the signal below a threshold value.

In some embodiments, the peak is temporally located before a time of the portion of the first derivative of the signal below the threshold value.

In some embodiments, identifying the decay comprises line-fitting a decaying portion of the signal corresponding to the sub-band.

In some embodiments, the signal corresponding to the sub-band comprises an early reflection portion between the peak and the decay portion.

In some embodiments, the early reflection portion comprises a portion of the signal corresponding to early reflections.

In some embodiments, the method further comprises from the early reflection portion: determining a reflection delay; and determining a reflection gain.

In some embodiments, an end of the decaying portion corresponds to a threshold signal level.

In some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

In some embodiments, the decay times and reverberation gains are combined by line-fitting.

In some embodiments, the decay times and reverberation gains are combined based on weights corresponding to the respective decay times and reverberation gains.

In some embodiments, the method further comprises repeating the method periodically.

In some embodiments, the system further comprises a server, wherein the server comprises at least one of the one or more processors.

In some embodiments, the system further comprises a wearable head device, wherein the wearable head device comprises at least one of the one or more processors.

In some embodiments, a system comprises one or more processors configured to execute a method comprising: receiving a signal; generating a direct path signal; deconvolving the signal based on the direct path signal; based on said deconvolving: determining a decay time; and determining a reverberation gain.

In some embodiments, the system further comprises a server, wherein the server comprises at least one of the one or more processors.

In some embodiments, the system further comprises a wearable head device, wherein the wearable head device comprises at least one of the one or more processors.

In some embodiments, a system comprises one or more processors configured to execute a method comprising associating one or more portions of an audio mapping of an environment to a plurality of voxels located in the environment. Each portion comprises an audio response property associated with a location of a respective voxel in the environment.

In some embodiments, the method further comprises: determining a location of a device, a first voxel of the plurality of voxels comprising the location of the device; and presenting, to the device, a sound of the environment based on an audio response property associated with the first voxel.

In some embodiments, the audio response property comprises at least one of reverberation gain, decay time, reflection delay, and reflection gain.

In some embodiments, volumes of the voxels are uniform.

In some embodiments, volumes of the voxels are non-uniform.

In some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

In some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

In some embodiments, the weight is based on a distance between the first voxel and a location of the first signal.

In some embodiments, the weight is based on an age of the audio response property associated with the first voxel.

In some embodiments, the weight is based on a determination of whether the first voxel is associated with a second audio response property, prior to association of the first audio response property.

In some embodiments, the weight is based on a confidence of the audio response property associated with the first voxel.

In some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

In some embodiments, the method further comprises: receiving the first signal at a first time; and receiving the second signal at a second time.

In some embodiments, the method further comprises: receiving, at a first device, the first signal; and receiving, at a second device, the second signal.

In some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

In some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

In some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain. In some embodiments, the plurality of voxels are associated with metadata, wherein the metadata comprises at least one of first measurement, time stamp, position, and confidence.

In some embodiments, the system further comprises a server, wherein the server comprises at least one of the one or more processors.

In some embodiments, the system further comprises a wearable head device, wherein the wearable head device comprises at least one of the one or more processors.

In some embodiments, a non-transitory computer-readable medium stores one or more instructions, which, when executed by one or more processors of an electronic device, cause the device to perform a method comprising: receiving a signal; and determining whether the signal meets a requirement of an analysis.

In some embodiments, the signal comprises an audio signal, and the analysis is associated with an audio mapping of an environment.

In some embodiments, the requirement comprises at least one of minimum signal-to-noise (SNR) constraint, signal duration constraint, collocation constraint, omnidirectional constraint, and impulsive signal constraint.

In some embodiments, determining whether the minimum SNR constraint is met comprises determining whether a signal level exceeds a threshold value.

In some embodiments, the threshold value is a second threshold value above the noise floor.

In some embodiments, the method further comprises tracking the noise floor.

In some embodiments, the method further comprises adjusting the noise floor.

In some embodiments, determining whether the duration constraint is met comprises determining whether a signal level exceeds a threshold value for at least a threshold duration of time.

In some embodiments, determining whether the collocation constraint is met comprises determining whether a source of the signal is within a threshold distance of a location of the receipt of the signal.

In some embodiments, determining whether the collocation constraint is met comprises applying a VAD process based on the signal.

In some embodiments, determining whether the omnidirectional constraint is met comprises determining whether a source of the signal comprises an omnidirectional source.

In some embodiments, determining whether the omnidirectional constraint is met comprises determining one or more of a radiation pattern for a source of the signal and an orientation for the source of the signal.

In some embodiments, determining whether the omnidirectional constraint is met comprises applying a VAD process based on the signal.

In some embodiments, determining whether the impulse constraint is met comprises determining whether the signal comprises one or more of an instantaneous signal, an impulse signal, and a transient signal.

In some embodiments, determining whether the impulse constraint is met comprises applying a dual envelope follower based on the signal.

In some embodiments, the method further comprises: determining the impulse constraint is not met; and in accordance with the determination that the impulse constraint is not met: converting the signal into a clean input stream; and comparing the clean input stream with the signal.

In some embodiments, the method further comprises in accordance with a determination that the analysis requirement is met, performing an above method; and in accordance with a determination that the analysis requirement is not met, forgoing performing an above method.

In some embodiments, the method further comprises smoothing the signal into an RMS envelope.

In some embodiments, wherein the method further comprises line-fitting the RMS envelope.

In some embodiments, the signal comprises a block of samples.

In some embodiments, receiving the signal further comprises detecting the signal via a microphone.

In some embodiments, receiving the signal further comprises receiving the signal from a storage.

In some embodiments, the signal is generated by a user.

In some embodiments, the signal is generated orally by the user.

In some embodiments, the signal is generated non-orally by the user.

In some embodiments, the signal is generated by a device different than a device receiving the signal.

In some embodiments, the method further comprises requesting generation of the signal, wherein the signal generated in response to a request to generate the signal.

In some embodiments, a non-transitory computer-readable medium stores one or more instructions, which, when executed by one or more processors of an electronic device, cause the device to perform a method comprising: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

In some embodiments, the signal meets an analysis requirement.

In some embodiments, the analysis requirement is at least one of minimum signal-to-noise (SNR) constraint, signal duration constraint, collocation constraint, omnidirectional constraint, and impulsive signal constraint.

In some embodiments, the method further comprises smoothing the signal using an RMS envelope.

In some embodiments, filtering the signal comprises using a FIR non-causal, zero-phase filter.

In some embodiments, filtering the signal comprises using a FIR non-causal quadrature mirror filter (QMF).

In some embodiments, the sub-bands comprises a low frequency sub-band, a mid frequency sub-band, and a high frequency sub-band.

In some embodiments, a number of sub-bands is greater than a number of decay time control points.

In some embodiments, identifying the peak of the signal comprises identifying a local minima of a first derivative of the signal.

In some embodiments, the peak is temporally located before a time of the local minima.

In some embodiments, identifying the peak of the signal comprises identifying a portion of a first derivative of the signal below a threshold value.

In some embodiments, the peak is temporally located before a time of the portion of the first derivative of the signal below the threshold value.

In some embodiments, identifying the decay comprises line-fitting a decaying portion of the signal corresponding to the sub-band.

In some embodiments, the signal corresponding to the sub-band comprises an early reflection portion between the peak and the decay portion.

In some embodiments, the early reflection portion comprises a portion of the signal corresponding to early reflections.

In some embodiments, the method further comprises, from the early reflection portion: determining a reflection delay; and determining a reflection gain.

In some embodiments, an end of the decaying portion corresponds to a threshold signal level.

In some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

In some embodiments, the decay times and reverberation gains are combined by line-fitting.

In some embodiments, the decay times and reverberation gains are combined based on weights corresponding to the respective decay times and reverberation gains.

In some embodiments, the method further comprises repeating the method of claim 166 periodically.

In some embodiments, a non-transitory computer-readable medium stores one or more instructions, which, when executed by one or more processors of an electronic device, cause the device to perform a method comprising: receiving a signal; generating a direct path signal; deconvolving the signal based on the direct path signal; based on said deconvolving: determining a decay time; and determining a reverberation gain.

In some embodiments, a non-transitory computer-readable medium stores one or more instructions, which, when executed by one or more processors of an electronic device, cause the device to perform a method comprising associating one or more portions of an audio mapping of an environment to a plurality of voxels located in the environment. Each portion comprises an audio response property associated with a location of a respective voxel in the environment.

In some embodiments, the method further comprises: determining a location of a device, a first voxel of the plurality of voxels comprising the location of the device; and presenting, to the device, a sound of the environment based on an audio response property associated with the first voxel.

In some embodiments, the audio response property comprises at least one of reverberation gain, decay time, reflection delay, and reflection gain.

In some embodiments, volumes of the voxels are uniform.

In some embodiments, volumes of the voxels are non-uniform.

In some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

In some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

In some embodiments, the weight is based on a distance between the first voxel and a location of the first signal.

In some embodiments, the weight is based on an age of the audio response property associated with the first voxel.

In some embodiments, the weight is based on a determination of whether the first voxel is associated with a second audio response property, prior to association of the first audio response property.

In some embodiments, the weight is based on a confidence of the audio response property associated with the first voxel.

In some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

In some embodiments, the method further comprises: receiving the first signal at a first time; and receiving the second signal at a second time.

In some embodiments, the method further comprises: receiving, at a first device, the first signal; and receiving, at a second device, the second signal.

In some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

In some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

In some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain.

In some embodiments, the plurality of voxels are associated with metadata, wherein the metadata comprises at least one of first measurement, time stamp, position, and confidence.

### BRIEF DESCRIPTION OF THE DRAWINGS

FIGS. 1A-IC illustrate example environments according to some embodiments of the disclosure.

FIGS. 2A-2B illustrate example wearable systems according to some embodiments of the disclosure.

FIG. 3 illustrates an example handheld controller that can be used in conjunction with an example wearable system according to some embodiments of the disclosure.

FIG. 4 illustrates an example auxiliary unit that can be used in conjunction with an example wearable system according to some embodiments of the disclosure.

FIGS. 5A-5B illustrate example functional block diagrams for an example wearable system according to some embodiments of the disclosure.

FIGS. 6A-6B illustrate exemplary methods of determining signals to be analyzed according to some embodiments of the disclosure.

FIGS. 7A-7B illustrate an exemplary method of signal analysis according to some embodiments of the disclosure.

FIG. 8 illustrates an exemplary environment according to some embodiments of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Like all people, a user of a MR system exists in a real environment—that is, a three-dimensional portion of the “real world,” and all of its contents, that are perceptible by the user. For example, a user perceives a real environment using one's ordinary human senses—sight, sound, touch, taste, smell—and interacts with the real environment by moving one's own body in the real environment. Locations in a real environment can be described as coordinates in a coordinate space; for example, a coordinate can comprise latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time t0, based on data associated with the virtual environment and/or input provided by a user, a state of the virtual environment at a second time td. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time td. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate—for instance, an audio signal corresponding to a composite of sounds in the virtual environment, and mixed and processed to simulate an audio signal that would be heard by a listener at the listener coordinate (e.g., using the methods and systems described herein) and present the audio signal to a user via one or more speakers.

Because a virtual environment exists as a computational structure, a user may not directly perceive a virtual environment using one's ordinary senses. Instead, a user can perceive a virtual environment indirectly, as presented to the user, for example by a display, speakers, haptic output devices, etc. Similarly, a user may not directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A MR system can present to the user, for example using a transmissive display and/or one or more speakers (which may, for example, be incorporated into a wearable head device), a MR environment (“MRE”) that combines aspects of a real environment and a virtual environment. In some embodiments, the one or more speakers may be external to the wearable head device. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE comprises a real lamp post (a real object) at a location coordinate, the virtual environment of the MRE may comprise a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may comprise a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may comprise a green, two-armed cactus—a prickly inanimate object—a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

In some examples, virtual objects may have characteristics that resemble corresponding real objects. For instance, a virtual character may be presented in a virtual or mixed reality environment as a life-like figure to provide a user an immersive mixed reality experience. With virtual characters having life-like characteristics, the user may feel like he or she is interacting with a real person. In such instances, it is desirable for actions such as muscle movements and gaze of the virtual character to appear natural. For example, movements of the virtual character should be similar to its corresponding real object (e.g., a virtual human should walk or move its arm like a real human). As another example, the gestures and positioning of the virtual human should appear natural, and the virtual human can initial interactions with the user (e.g., the virtual human can lead a collaborative experience with the user). Presentation of virtual characters or objects having life-like audio responses is described in more detail herein.

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment because, as noted herein, a user may not directly perceive or interact with a virtual environment a user of an MR system may find it more intuitive and natural to interact with a virtual object by seeing, hearing, and touching a corresponding real object in his or her own real environment. This level of interactivity may heighten a user's feelings of immersion, connection, and engagement with a virtual environment. Similarly, by simultaneously presenting a real environment and a virtual environment, mixed reality systems may reduce negative psychological feelings (e.g., cognitive dissonance) and negative physical feelings (e.g., motion sickness) associated with VR systems. Mixed reality systems further offer many possibilities for applications that may augment or alter our experiences of the real world.

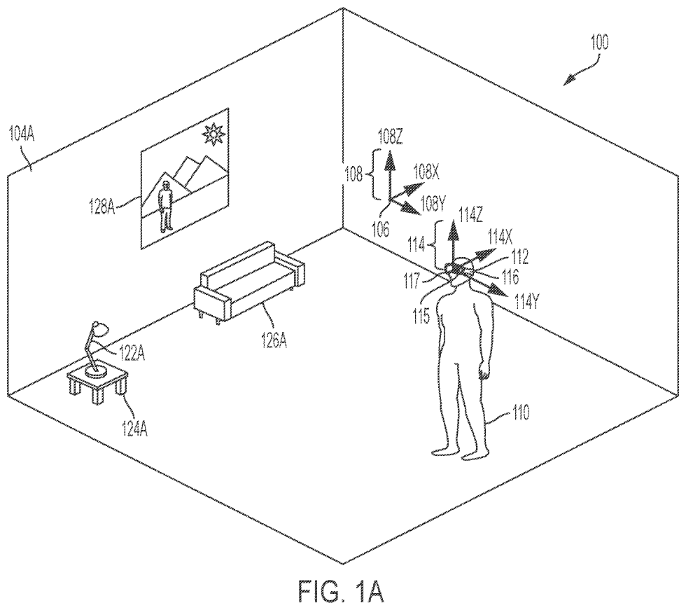

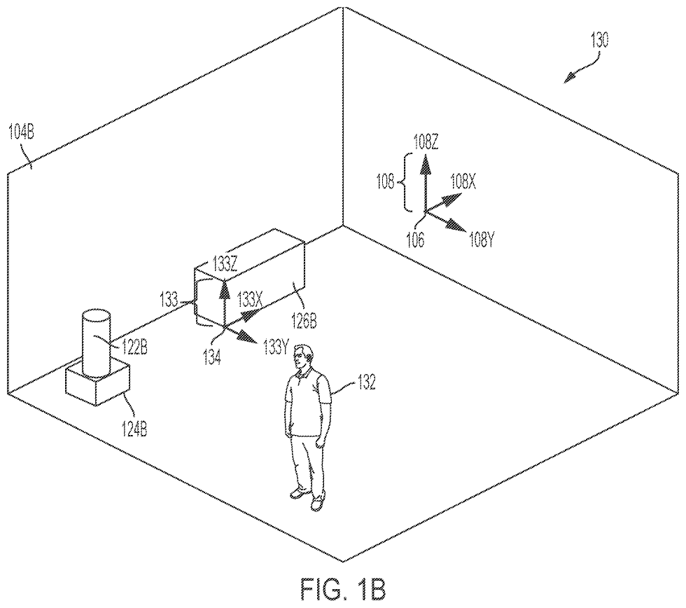

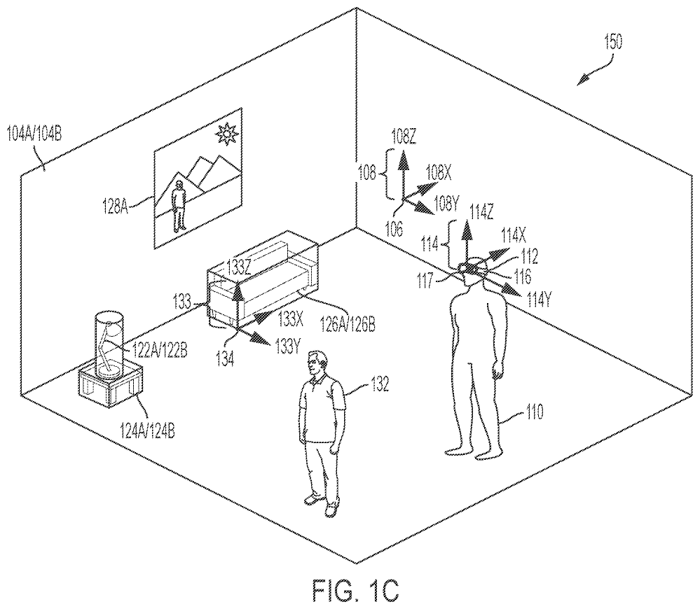

FIG. 1A illustrates an exemplary real environment 100 in which a user 110 uses a mixed reality system 112. Mixed reality system 112 may comprise a display (e.g., a transmissive display), one or more speakers, and one or more sensors (e.g., a camera), for example as described herein. The real environment 100 shown comprises a rectangular room 104A, in which user 110 is standing; and real objects 122A (a lamp), 124A (a table), 126A (a sofa), and 128A (a painting). Room 104A may be spatially described with a location coordinate (e.g., coordinate system 108); locations of the real environment 100 may be described with respect to an origin of the location coordinate (e.g., point 106). As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a quaternion matrix, or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a quaternion matrix, or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an exemplary virtual environment 130 that corresponds to real environment 100. The virtual environment 130 shown comprises a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, 126A. Virtual environment 130 additionally comprises a virtual character 132, which may not correspond to any real object in real environment 100. Real object 128A in real environment 100 may not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a quaternion matrix, or other rotation matrix), or other suitable representation can characterize a transformation between the persistent coordinate system 133 space and the environment/world coordinate system 108 space. In some embodiments, each of the virtual objects 122B, 124B, 126B, and 132 may have its own persistent coordinate point relative to the origin point 134 of the persistent coordinate system 133. In some embodiments, there may be multiple persistent coordinate systems and each of the virtual objects 122B, 124B, 126B, and 132 may have its own persistent coordinate points relative to one or more persistent coordinate systems.

Persistent coordinate data may be coordinate data that persists relative to a physical environment. Persistent coordinate data may be used by MR systems (e.g., MR system 112, 200) to place persistent virtual content, which may not be tied to movement of a display on which the virtual object is being displayed. For example, a two-dimensional screen may display virtual objects relative to a position on the screen. As the two-dimensional screen moves, the virtual content may move with the screen. In some embodiments, persistent virtual content may be displayed in a corner of a room. A MR user may look at the corner, see the virtual content, look away from the corner (where the virtual content may no longer be visible because the virtual content may have moved from within the user's field of view to a location outside the user's field of view due to motion of the user's head), and look back to see the virtual content in the corner (similar to how a real object may behave).

In some embodiments, persistent coordinate data (e.g., a persistent coordinate system and/or a persistent coordinate frame) can include an origin point and three axes. For example, a persistent coordinate system may be assigned to a center of a room by a MR system. In some embodiments, a user may move around the room, out of the room, re-enter the room, etc., and the persistent coordinate system may remain at the center of the room (e.g., because it persists relative to the physical environment). In some embodiments, a virtual object may be displayed using a transform to persistent coordinate data, which may enable displaying persistent virtual content. In some embodiments, a MR system may use simultaneous localization and mapping to generate persistent coordinate data (e.g., the MR system may assign a persistent coordinate system to a point in space). In some embodiments, a MR system may map an environment by generating persistent coordinate data at regular intervals (e.g., a MR system may assign persistent coordinate systems in a grid where persistent coordinate systems may be at least within five feet of another persistent coordinate system).

In some embodiments, persistent coordinate data may be generated by a MR system and transmitted to a remote server. In some embodiments, a remote server may be configured to receive persistent coordinate data. In some embodiments, a remote server may be configured to synchronize persistent coordinate data from multiple observation instances. For example, multiple MR systems may map the same room with persistent coordinate data and transmit that data to a remote server. In some embodiments, the remote server may use this observation data to generate canonical persistent coordinate data, which may be based on the one or more observations. In some embodiments, canonical persistent coordinate data may be more accurate and/or reliable than a single observation of persistent coordinate data. In some embodiments, canonical persistent coordinate data may be transmitted to one or more MR systems. For example, a MR system may use image recognition and/or location data to recognize that it is located in a room that has corresponding canonical persistent coordinate data (e.g., because other MR systems have previously mapped the room). In some embodiments, the MR system may receive canonical persistent coordinate data corresponding to its location from a remote server.

With respect to FIGS. 1A and 1B, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a quaternion matrix, or other rotation matrix), or other suitable representation can characterize a transformation between a real environment coordinate space and a virtual environment coordinate space.

FIG. 1C illustrates an exemplary MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As described herein, origin point 106 acts as an origin for a coordinate space corresponding to MRE 150, and coordinate system 108 defines an x-axis, y-axis, and z-axis for the coordinate space.

In the example shown, mixed reality objects comprise corresponding pairs of real objects and virtual objects (e.g., 122A/122B, 124A/124B, 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described herein may also incorporate audio aspects. For instance, in MRE 150, virtual character 132 could be associated with one or more audio signals, such as a footstep sound effect that is generated as the character walks around MRE 150. As described herein, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

Example mixed reality system 112 can include a wearable head device (e.g., a wearable augmented reality or mixed reality head device) comprising a display (which may comprise left and right transmissive displays, which may be near-eye displays, and associated components for coupling light from the displays to the user's eyes); left and right speakers (e.g., positioned adjacent to the user's left and right ears, respectively); an inertial measurement unit (IMU) (e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability, mobile network (e.g., 4G, 5G) capability) to communicate with other devices and systems, including neural networks (e.g., in the cloud) for data processing and training data associated with presentation of elements (e.g., virtual character 132) in the MRE 150 and other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described herein.

In some embodiments, an animation rig is used to present the virtual character 132 in the MRE 150. Although the animation rig is described with respect to virtual character 132, it is understood that the animation rig may be associated with other characters (e.g., a human character, an animal character, an abstract character) in the MRE 150.

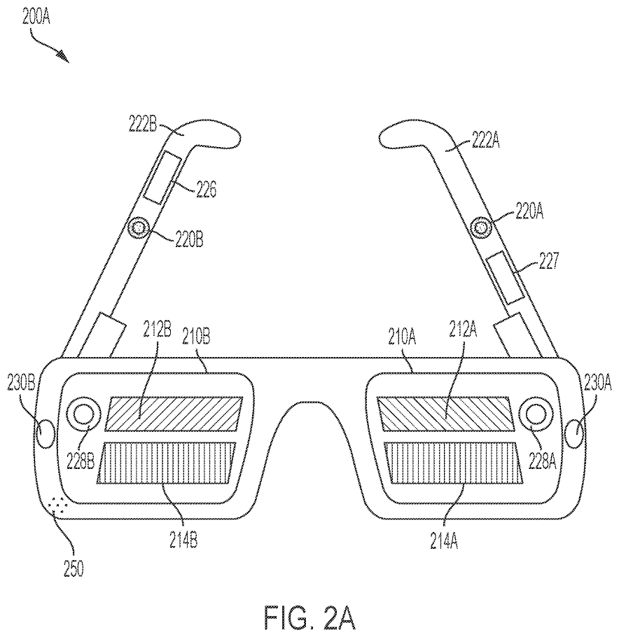

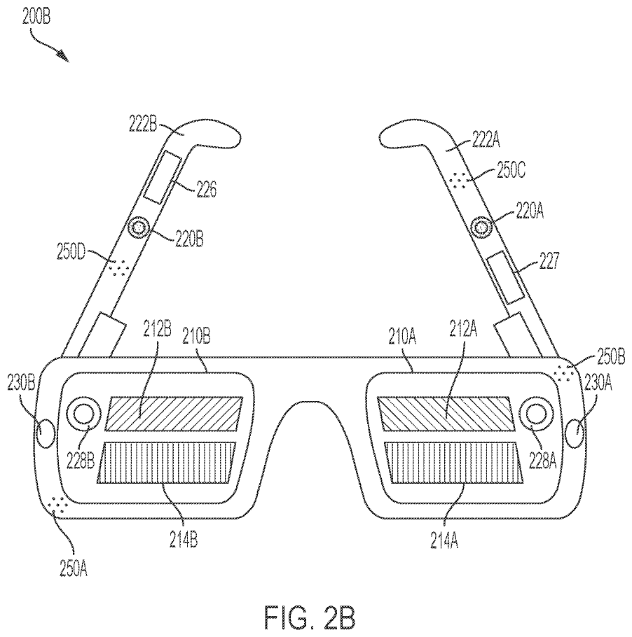

FIG. 2A illustrates an example wearable head device 200A configured to be worn on the head of a user. Wearable head device 200A may be part of a broader wearable system that comprises one or more components, such as a head device (e.g., wearable head device 200A), a handheld controller (e.g., handheld controller 300 described below), and/or an auxiliary unit (e.g., auxiliary unit 400 described below). In some examples, wearable head device 200A can be used for AR, MR, or XR systems or applications. Wearable head device 200A can comprise one or more displays, such as displays 210A and 210B (which may comprise left and right transmissive displays, and associated components for coupling light from the displays to the user's eyes, such as orthogonal pupil expansion (OPE) grating sets 212A/212B and exit pupil expansion (EPE) grating sets 214A/214B); left and right acoustic structures, such as speakers 220A and 220B (which may be mounted on temple arms 222A and 222B, and positioned adjacent to the user's left and right ears, respectively); one or more sensors such as infrared sensors, accelerometers, GPS units, inertial measurement units (IMUs, e.g. IMU 226), acoustic sensors (e.g., microphones 250); orthogonal coil electromagnetic receivers (e.g., receiver 227 shown mounted to the left temple arm 222A); left and right cameras (e.g., depth (time-of-flight) cameras 230A and 230B) oriented away from the user; and left and right eye cameras oriented toward the user (e.g., for detecting the user's eye movements)(e.g., eye cameras 228A and 228B). However, wearable head device 200A can incorporate any suitable display technology, and any suitable number, type, or combination of sensors or other components without departing from the scope of the invention. In some examples, wearable head device 200A may incorporate one or more microphones 250 configured to detect audio signals generated by the user's voice; such microphones may be positioned adjacent to the user's mouth and/or on one or both sides of the user's head. In some examples, wearable head device 200A may incorporate networking features (e.g., Wi-Fi capability) to communicate with other devices and systems, including other wearable systems. Wearable head device 200A may further include components such as a battery, a processor, a memory, a storage unit, or various input devices (e.g., buttons, touchpads); or may be coupled to a handheld controller (e.g., handheld controller 300) or an auxiliary unit (e.g., auxiliary unit 400) that comprises one or more such components. In some examples, sensors may be configured to output a set of coordinates of the head-mounted unit relative to the user's environment, and may provide input to a processor performing a Simultaneous Localization and Mapping (SLAM) procedure and/or a visual odometry algorithm. In some examples, wearable head device 200A may be coupled to a handheld controller 300, and/or an auxiliary unit 400, as described further below.

FIG. 2B illustrates an example wearable head device 200B (that can correspond to wearable head device 200A) configured to be worn on the head of a user. In some embodiments, wearable head device 200B can include a multi-microphone configuration, including microphones 250A, 250B, 250C, and 250D. Multi-microphone configurations can provide spatial information about a sound source in addition to audio information. For example, signal processing techniques can be used to determine a relative position of an audio source to wearable head device 200B based on the amplitudes of the signals received at the multi-microphone configuration. If the same audio signal is received with a larger amplitude at microphone 250A than at 250B, it can be determined that the audio source is closer to microphone 250A than to microphone 250B. Asymmetric or symmetric microphone configurations can be used. In some embodiments, it can be advantageous to asymmetrically configure microphones 250A and 250B on a front face of wearable head device 200B. For example, an asymmetric configuration of microphones 250A and 250B can provide spatial information pertaining to height (e.g., a distance from a first microphone to a voice source (e.g., the user's mouth, the user's throat) and a second distance from a second microphone to the voice source are different). This can be used to distinguish a user's speech from other human speech. For example, a ratio of amplitudes received at microphone 250A and at microphone 250B can be expected for a user's mouth to determine that an audio source is from the user. In some embodiments, a symmetrical configuration may be able to distinguish a user's speech from other human speech to the left or right of a user. Although four microphones are shown in FIG. 2B, it is contemplated that any suitable number of microphones can be used, and the microphone(s) can be arranged in any suitable (e.g., symmetrical or asymmetrical) configuration.

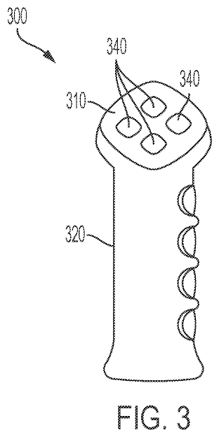

FIG. 3 illustrates an example mobile handheld controller component 300 of an example wearable system. In some examples, handheld controller 300 may be in wired or wireless communication with wearable head device 200A and/or 200B and/or auxiliary unit 400 described below. In some examples, handheld controller 300 includes a handle portion 320 to be held by a user, and one or more buttons 340 disposed along a top surface 310. In some examples, handheld controller 300 may be configured for use as an optical tracking target; for example, a sensor (e.g., a camera or other optical sensor) of wearable head device 200A and/or 200B can be configured to detect a position and/or orientation of handheld controller 300 which may, by extension, indicate a position and/or orientation of the hand of a user holding handheld controller 300. In some examples, handheld controller 300 may include a processor, a memory, a storage unit, a display, or one or more input devices, such as ones described herein. In some examples, handheld controller 300 includes one or more sensors (e.g., any of the sensors or tracking components described herein with respect to wearable head device 200A and/or 200B). In some examples, sensors can detect a position or orientation of handheld controller 300 relative to wearable head device 200A and/or 200B or to another component of a wearable system. In some examples, sensors may be positioned in handle portion 320 of handheld controller 300, and/or may be mechanically coupled to the handheld controller. Handheld controller 300 can be configured to provide one or more output signals, corresponding, for example, to a pressed state of the buttons 340; or a position, orientation, and/or motion of the handheld controller 300 (e.g., via an IMU). Such output signals may be used as input to a processor of wearable head device 200A and/or 200B, to auxiliary unit 400, or to another component of a wearable system. In some examples, handheld controller 300 can include one or more microphones to detect sounds (e.g., a user's speech, environmental sounds), and in some cases provide a signal corresponding to the detected sound to a processor (e.g., a processor of wearable head device 200A and/or 200B).

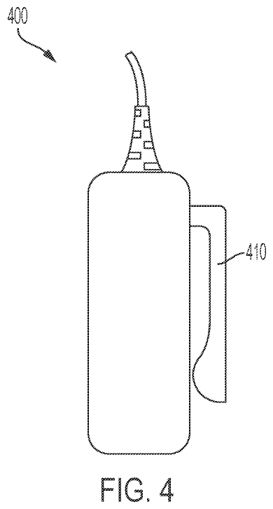

FIG. 4 illustrates an example auxiliary unit 400 of an example wearable system. In some examples, auxiliary unit 400 may be in wired or wireless communication with wearable head device 200A and/or 200B and/or handheld controller 300. The auxiliary unit 400 can include a battery to primarily or supplementally provide energy to operate one or more components of a wearable system, such as wearable head device 200A and/or 200B and/or handheld controller 300 (including displays, sensors, acoustic structures, processors, microphones, and/or other components of wearable head device 200A and/or 200B or handheld controller 300). In some examples, auxiliary unit 400 may include a processor, a memory, a storage unit, a display, one or more input devices, and/or one or more sensors, such as ones described herein. In some examples, auxiliary unit 400 includes a clip 410 for attaching the auxiliary unit to a user (e.g., attaching the auxiliary unit to a belt worn by the user). An advantage of using auxiliary unit 400 to house one or more components of a wearable system is that doing so may allow larger or heavier components to be carried on a user's waist, chest, or back which are relatively well suited to support larger and heavier objects rather than mounted to the user's head (e.g., if housed in wearable head device 200A and/or 200B) or carried by the user's hand (e.g., if housed in handheld controller 300). This may be particularly advantageous for relatively heavier or bulkier components, such as batteries.

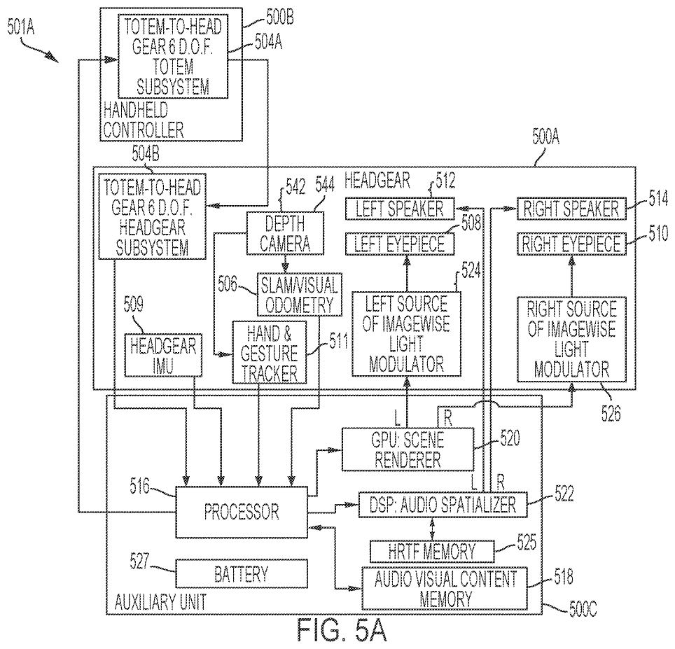

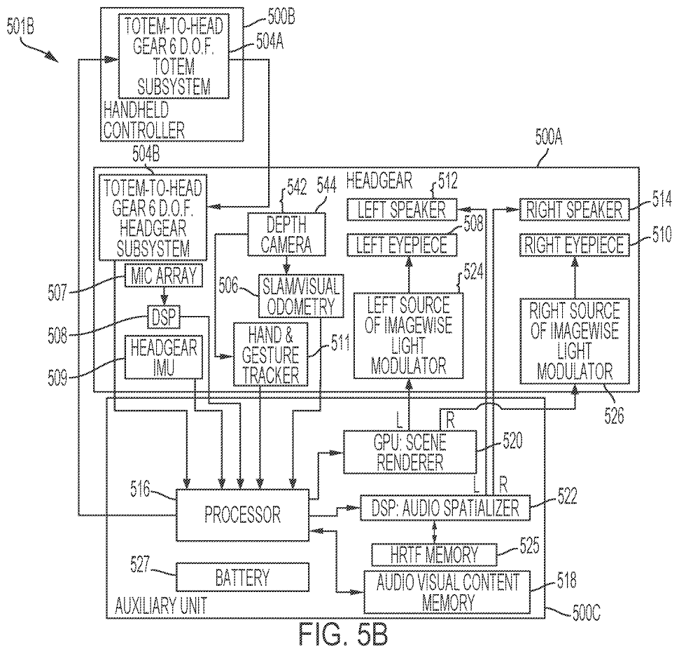

FIG. 5A shows an example functional block diagram that may correspond to an example wearable system 501A; such system may include example wearable head device 200A and/or 200B, handheld controller 300, and auxiliary unit 400 described herein. In some examples, the wearable system 501A could be used for AR, MR, or XR applications. As shown in FIG. 5, wearable system 501A can include example handheld controller 500B, referred to here as a “totem” (and which may correspond to handheld controller 300); the handheld controller 500B can include a totem-to-headgear six degree of freedom (6DOF) totem subsystem 504A. Wearable system 501A can also include example headgear device 500A (which may correspond to wearable head device 200A and/or 200B); the headgear device 500A includes a totem-to-headgear 6DOF headgear subsystem 504B. In the example, the 6DOF totem subsystem 504A and the 6DOF headgear subsystem 504B cooperate to determine six coordinates (e.g., offsets in three translation directions and rotation along three axes) of the handheld controller 500B relative to the headgear device 500A. The six degrees of freedom may be expressed relative to a coordinate system of the headgear device 500A. The three translation offsets may be expressed as X, Y, and Z offsets in such a coordinate system, as a translation matrix, or as some other representation. The rotation degrees of freedom may be expressed as sequence of yaw, pitch and roll rotations; as vectors; as a rotation matrix; as a quaternion; or as some other representation. In some examples, one or more depth cameras 544 (and/or one or more non-depth cameras) included in the headgear device 500A; and/or one or more optical targets (e.g., buttons 340 of handheld controller 300 as described, dedicated optical targets included in the handheld controller) can be used for 6DOF tracking. In some examples, the handheld controller 500B can include a camera, as described; and the headgear device 500A can include an optical target for optical tracking in conjunction with the camera. In some examples, the headgear device 500A and the handheld controller 500B each include a set of three orthogonally oriented solenoids which are used to wirelessly send and receive three distinguishable signals. By measuring the relative magnitude of the three distinguishable signals received in each of the coils used for receiving, the 6DOF of the handheld controller 500B relative to the headgear device 500A may be determined. In some examples, 6DOF totem subsystem 504A can include an Inertial Measurement Unit (IMU) that is useful to provide improved accuracy and/or more timely information on rapid movements of the handheld controller 500B.

FIG. 5B shows an example functional block diagram that may correspond to an example wearable system 501B (which can correspond to example wearable system 501A). In some embodiments, wearable system 501B can include microphone array 507, which can include one or more microphones arranged on headgear device 500A. In some embodiments, microphone array 507 can include four microphones. Two microphones can be placed on a front face of headgear 500A, and two microphones can be placed at a rear of head headgear 500A (e.g., one at a back-left and one at a back-right), such as the configuration described with respect to FIG. 2B. The microphone array 507 can include any suitable number of microphones, and can include a single microphone. In some embodiments, signals received by microphone array 507 can be transmitted to DSP 508. DSP 508 can be configured to perform signal processing on the signals received from microphone array 507. For example, DSP 508 can be configured to perform noise reduction, acoustic echo cancellation, and/or beamforming on signals received from microphone array 507. DSP 508 can be configured to transmit signals to processor 516. In some embodiments, the system 501B can include multiple signal processing stages that may each be associated with one or more microphones. In some embodiments, the multiple signal processing stages are each associated with a microphone of a combination of two or more microphones used for beamforming. In some embodiments, the multiple signal processing stages are each associated with noise reduction or echo-cancellation algorithms used to pre-process a signal used for either voice onset detection, key phrase detection, or endpoint detection.

In some examples involving augmented reality or mixed reality applications, it may be desirable to transform coordinates from a local coordinate space (e.g., a coordinate space fixed relative to headgear device 500A) to an inertial coordinate space, or to an environmental coordinate space. For instance, such transformations may be necessary for a display of headgear device 500A to present a virtual object at an expected position and orientation relative to the real environment (e.g., a virtual person sitting in a real chair, facing forward, regardless of the position and orientation of headgear device 500A), rather than at a fixed position and orientation on the display (e.g., at the same position in the display of headgear device 500A). This can maintain an illusion that the virtual object exists in the real environment (and does not, for example, appear positioned unnaturally in the real environment as the headgear device 500A shifts and rotates). In some examples, a compensatory transformation between coordinate spaces can be determined by processing imagery from the depth cameras 544 (e.g., using a Simultaneous Localization and Mapping (SLAM) and/or visual odometry procedure) in order to determine the transformation of the headgear device 500A relative to an inertial or environmental coordinate system. In the example shown in FIG. 5, the depth cameras 544 can be coupled to a SLAM/visual odometry block 506 and can provide imagery to block 506. The SLAM/visual odometry block 506 implementation can include a processor configured to process this imagery and determine a position and orientation of the user's head, which can then be used to identify a transformation between a head coordinate space and a real coordinate space. Similarly, in some examples, an additional source of information on the user's head pose and location is obtained from an IMU 509 of headgear device 500A. Information from the IMU 509 can be integrated with information from the SLAM/visual odometry block 506 to provide improved accuracy and/or more timely information on rapid adjustments of the user's head pose and position.

In some examples, the depth cameras 544 can supply 3D imagery to a hand gesture tracker 511, which may be implemented in a processor of headgear device 500A. The hand gesture tracker 511 can identify a user's hand gestures, for example by matching 3D imagery received from the depth cameras 544 to stored patterns representing hand gestures. Other suitable techniques of identifying a user's hand gestures will be apparent.

In some examples, one or more processors 516 may be configured to receive data from headgear subsystem 504B, the IMU 509, the SLAM/visual odometry block 506, depth cameras 544, microphones 550; and/or the hand gesture tracker 511. The processor 516 can also send and receive control signals from the 6DOF totem system 504A. The processor 516 may be coupled to the 6DOF totem system 504A wirelessly, such as in examples where the handheld controller 500B is untethered. Processor 516 may further communicate with additional components, such as an audio-visual content memory 518, a Graphical Processing Unit (GPU) 520, and/or a Digital Signal Processor (DSP) audio spatializer 522. The DSP audio spatializer 522 may be coupled to a Head Related Transfer Function (HRTF) memory 525. The GPU 520 can include a left channel output coupled to the left source of imagewise modulated light 524 and a right channel output coupled to the right source of imagewise modulated light 526. GPU 520 can output stereoscopic image data to the sources of imagewise modulated light 524, 526. The DSP audio spatializer 522 can output audio to a left speaker 512 and/or a right speaker 514. The DSP audio spatializer 522 can receive input from processor 519 indicating a direction vector from a user to a virtual sound source (which may be moved by the user, e.g., via the handheld controller 500B). Based on the direction vector, the DSP audio spatializer 522 can determine a corresponding HRTF (e.g., by accessing a HRTF, or by interpolating multiple HRTFs). The DSP audio spatializer 522 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment that is, by presenting a virtual sound that matches a user's expectations of what that virtual sound would sound like if it were a real sound in a real environment.

In some examples, such as shown in FIG. 5, one or more of processor 516, GPU 520, DSP audio spatializer 522, HRTF memory 525, and audio/visual content memory 518 may be included in an auxiliary unit 500C (which may correspond to auxiliary unit 400). The auxiliary unit 500C may include a battery 527 to power its components and/or to supply power to headgear device 500A and/or handheld controller 500B. Including such components in an auxiliary unit, which can be mounted to a user's waist, can limit or reduce the size and weight of headgear device 500A, which can in turn reduce fatigue of a user's head and neck. In some embodiments, the auxiliary unit is a cell phone, tablet, or a second computing device.

While FIGS. 5A and 5B present elements corresponding to various components of an example wearable systems 501A and 501B, various other suitable arrangements of these components will become apparent to those skilled in the art. For example, the headgear device 500A illustrated in FIG. 5A or FIG. 5B may include a processor and/or a battery (not shown). The included processor and/or battery may operate together with or operate in place of the processor and/or battery of the auxiliary unit 500C. Generally, as another example, elements presented or functionalities described with respect to FIG. 5 as being associated with auxiliary unit 500C could instead be associated with headgear device 500A or handheld controller 500B. Furthermore, some wearable systems may forgo entirely a handheld controller 500B or auxiliary unit 500C. Such changes and modifications are to be understood as being included within the scope of the disclosed examples.

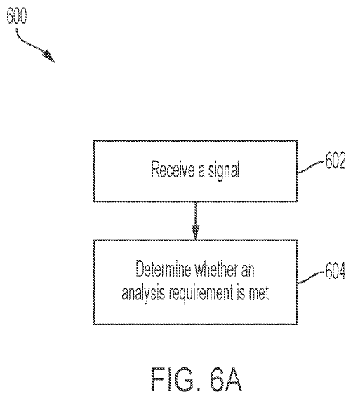

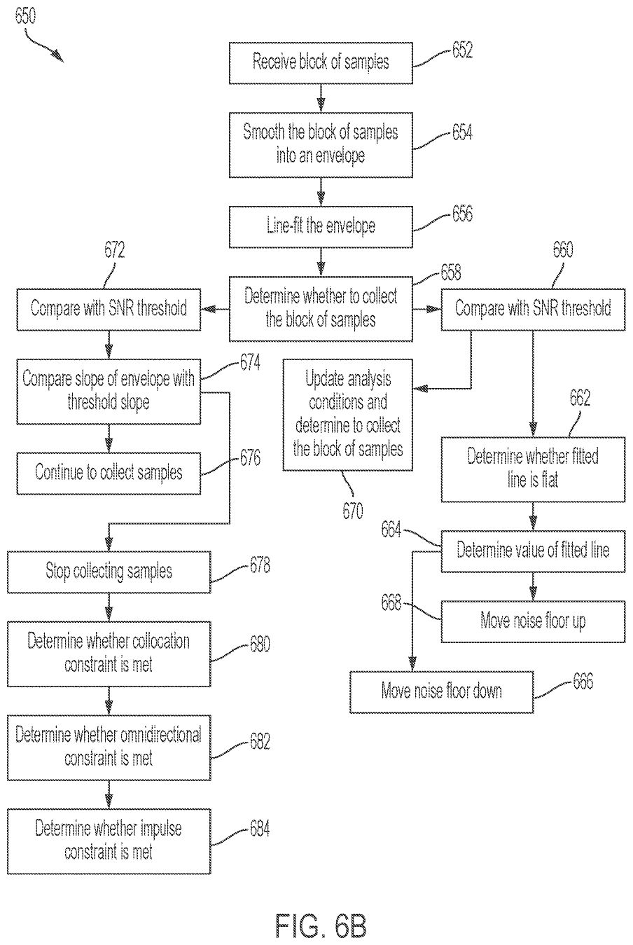

FIG. 6A illustrates an exemplary method 600 of determining signals to be analyzed according to some embodiments of the disclosure. In some embodiments, the method 600 determines whether a signal is to be analyzed in method 700. For example, the method 600 determines whether a signal comprises characteristics for a device or a system to extract mapping information (e.g., reverberation, reflection, acoustic environment fingerprint of the environment) about an environment of the signal (e.g., an audio signal recorded in an AR, MR, or XR environment).

As used herein, acoustic environment fingerprint may refer to a collection of reverberation or acoustic properties (e.g., of a mixed-reality environment), such as frequency-dependent decay time, reverb gain, reverb decay time, reverb decay time low-frequency ratio, reverb decay time high-frequency ratio, reverb delay, reflection gain (e.g., late reflection gain), reflection delay (e.g., late reflection delay). In some examples, reverb decay time, reverb decay time low-frequency ratio, and reverb decay time high-frequency ratio together form the frequency-dependent decay time with a resolution of low-mid-high. The decay time may quantify how quickly a sound decays (e.g., in the AR, MR, or XR environment for a particular energy band). In some embodiments, the decay time is represented as “t60,” which is a time for a sound to decay by 60 dB. The reverb gain may quantify a relative energy level of a decay sound (e.g., at a particular time after a sound is introduced) to energy injected (e.g., the energy of the sound when it is introduced). The reverb delay may refer to a time between the injection of energy (e.g., when a sound is introduced) and a maximum amount of stochastic decaying sound. In some embodiments, the reverb delay is frequency dependent (e.g., the reverb gain comprises a broadband component, the reverb gain comprises a plurality of sub-band gains).

In some embodiments, the signal comprises one or more input streams received in real time and the determination of whether the signal should be captured for analysis (e.g., to be performed in method 700) is also determined in real time.

Although the method 600 is illustrated as including the described steps, it is understood that a different order of steps, additional steps, or fewer steps may be included without departing from the scope of the disclosure. For example, steps of method 600 may be performed with steps of other disclosed methods (e.g., method 650, method 700, methods described with respect to environment 800). As another example, the method 600 may determine that a signal is to be analyzed based on fewer requirements than described. As yet another example, the method 600 may determine that a signal is to be analyzed based on other requirements than described.

In some embodiments, computation, determination, calculation, or derivation steps of method 600 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR, MR, or XR system and/or using a server (e.g., in the cloud).

In some embodiments, the method 600 includes receiving a signal (step 602). In some examples, the signal comprises a block of samples (e.g., hundreds of samples, 256 samples, 512 samples) are received. In some embodiments, the signal comprises audio data, and the audio data may comprise information for mapping an environment of the audio (e.g., the audio comprises information that allows an audio response of the environment to be derived). In some embodiments, the signal is received via a microphone (e.g., microphone 250; microphones 250A, 250B, 250C, and 250D; microphone of handheld controller 300; microphone array 507). For example, the signal comprises a short utterance from a user speaking to the microphone. As another example, the signal comprises energy having a short duration, such as a sound of a clap, a knock, a snap, and the likes (e.g., created by the user into the microphone). In some embodiments, the signal is received by retrieving data from a storage (e.g., from a storage of wearable head device 200A, wearable head device 200B, handheld controller 300, wearable system 501A, wearable system 501B, from a storage of a server).

In some embodiments, step 602 is performed in response to a request to map an environment's audio response (e.g., reverberation of an AR, MR, or XR environment). In some embodiments, the request is initiated by a user input to the receiving device (e.g., the user wishes to map the environment's audio response using the receiving device). In some embodiments, the request is initiated by the receiving device (e.g., the receiving device requires the received signals to map the environment's audio response (e.g., to accurately present content of the environment)). In some embodiments, the receiving device provides an indication to a user to provide the signal. For example, in response to the request to map the environment's audio response, the receiving device provides directions for the user to provide the signal (e.g., display directions to make short utterances (e.g., orally make a clicking sound, popping sound, or the likes), display direction to generate a signal comprising energy having a short duration (e.g., clap, knock, snap, or the likes)).

In some embodiments, the method 600 includes determining whether the signal meets an analysis requirement (step 604). In some embodiments, the step 604 comprises determining whether a signal is qualified to be analyzed in method 700 (e.g., to derive environmental mapping information, to derive reverberation/reflection information of the environment, to derive acoustic environment fingerprint of the environment) based on one or more requirements. For example, the requirements include minimum signal-to-noise (SNR) constraint, signal duration constraint, collocation constraint, omnidirectional constraint, and impulsive signal constraint. It is understood that other requirements may be used to determine whether the signal is to be analyzed.

In some embodiments, the requirement prevents signals yielding inaccurate results from being analyzed for environmental mapping information (e.g., reverberation/reflection properties of the environment, acoustic environment fingerprint of the environment). In some embodiments, as described in more detail herein, the requirement allows identification of signal that may require compensation for yielding more accurate analysis for environmental mapping information (e.g., reverberation/reflection properties of the environment, acoustic environment fingerprint of the environment).

In some embodiments, determining whether the minimal SNR constraint is met comprises detecting a presence of a signal level of the signal above a tracked noise floor. In some embodiments, a threshold difference between the signal level of the signal and the tracked noise floor is 20 dB. That is, in some embodiments, if the difference between the signal level of the signal and the tracked noise floor is above 20 dB, then the signal meets the minimal SNR constraint. In some embodiments, a moving level tracker tracks a noise floor level. In some embodiments, determining whether the minimal SNR constraint is met comprises determining whether the signal is strong enough to drive or excite the environment.

For example, a block of samples (e.g., received from step 602) (e.g., a block of hundreds (e.g., 256, 512) of samples) is smoothed into an RMS envelope having a shorter (e.g., 16-32 samples) time scale. A line may be fitted against the RMS envelope. If the absolute value of the slope of the fitted line is below a threshold slope (e.g., the energy level of the block of samples is relatively flat), the noise floor is adjusted. In some embodiments, the line may be fitted against the block of samples without smoothing into an RMS envelope. Although the block of samples is described to be smoothed into an RMS envelope, it is understood that the block of samples may be smoothed into other types of envelopes (e.g., running energy).

In some embodiments, if the block average value is below a current noise floor, a larger percentage (e.g., greater than 50%) of the noise floor moves toward the block average value. In some embodiments, if the block average is above a current noise floor, a smaller percentage (e.g., less than 50%) of the noise floor moves toward the block average value.

In some embodiments, the noise floor continuously moves at a slow rate when the received signal is present. In some embodiments, the noise floor continuously moves at a slower rate (compared to the slow rate when the received signal is present) when the received signal is not present. In some embodiments, the noise floor continuously moves at a same rate (compared to the rate when the received signal is present) when the received signal is not present. The slow rate of noise floor movement allows for correct and gradual adjustment to a noisier environment (e.g., to prevent noise in a new, noisier environment from being interpreted as a signal for environmental mapping analysis). In some examples, in an environment having an audio response that comprises short decay time, the rise of the noise floor may be negligible. In some examples, in an environment having an audio response that comprises long decay time, after a signal is received and whether the signal meets a requirement for analysis is determined, the noise floor quickly resets to an initial level (e.g., quickly falls or returns to a noise floor level without the received signal). In some embodiments, after a signal is received, a time for subsequent noise floor adaptation may be shortened, allowing the noise floor to more quickly adjust to the received ambient noise level.

In some embodiments, determining whether the signal duration constraint is met comprises determining whether the signal duration is long enough to enable a measurable delay. For example, in some embodiments, a device receiving the signal (e.g., wearable head device 200A, wearable head device 200B, handheld controller 300, wearable system 501A, wearable system 501B, a server) determines whether the duration of the signal is above a signal duration threshold (e.g., above the noise floor, above the noise floor by a threshold amount (e.g., 20 dB)), a continuous duration above a minimum SNR) beyond a threshold amount of time. In some embodiments, the determination of whether the signal duration constraint is met may be performed when evaluating whether the signal meets the minimal SNR constraint (e.g., determining whether the duration of the signal is above the noise floor, above the noise floor by a threshold amount (e.g., 20 dB), above a minimum SNR beyond a threshold amount of time) beyond a threshold amount of time.

In some embodiments, determining whether the collocation constraint is met comprises determining whether a source of the signal is collocated with the receiving device. In some embodiments, confirming that the source of the signal is collocated with the receiving device ensures the accuracy of reverb gain or reflection gain analysis (e.g., performed in method 700); signals from sources not collocated with the receiving device (e.g., the source is distant from the receiving device) may result in inaccurate reverb gain or reflection gain determination.

In some embodiments, determining whether the collocation constraint is met comprises determining a location of the source of the signal. In some embodiments, a distance between the source of the signal and the location of the receiving device affects an accuracy of subsequent analysis (e.g., method 700) (e.g., expressed as differences of environment coordinates of the source and the receiving device location). Therefore, in some embodiments, determining whether the collocation constraint is met comprises determining whether the source of the signal is within a threshold distance of the location of the receiving device.

In some embodiments, the distance is known (e.g., based on coordinate of the source in the environment, the source of the signal is the user of the receiving device), and the collocation constraint may be relaxed because an uncertainty associated with an unknown source distance is reduced. In some embodiments, to better meet the collocation constraint, a source of the signal is required to be localized (e.g., within a threshold distance between the source and the receiving device, only signal generated by a user may be used for environmental mapping (e.g., the source is proximal to the receiving device)).

In some embodiments, the distance is determined by a time delay and level difference between the generation of the signal and receipt of a reflected or reverberated signal. In some embodiments, the distance is determined using beamforming analysis. In some embodiments, the distance is determined using auto-correlation analysis. For example, a differential of peaks are auto-correlated, and a distance is estimated based on a difference needed to correlate the peaks. If the distance is estimated to be greater than a threshold distance, then the collocation constraint is not met.

In some embodiments, a neural network is trained to identify the distance between the signal and the receiving device. For example, the neural network is trained to identify sound sources within a range (e.g., within a localization range to meet the collocation constraint). As another example, the neural network is trained to identify specific sound sources that are known to be proximal to the receiving device (e.g., a signal generated by a user (e.g., a user's voice, hand-clap, snap, pop, and the likes)). In some embodiments, voice activated detection (VAD) (e.g., DeepVAD) is used to identify user speech for determining whether a collocation constraint is met. For example, the VAD identifies the user's speech, and in accordance with this identification, the signal is determined to be collocated with the receiving device and to meet the collocation constraint.

In some embodiments, determining whether the omnidirectional constraint is met comprises determining whether a source of the signal comprises an omnidirectional source. In some embodiments, confirming that the source of the signal is omnidirectional ensures the accuracy of reverb gain or reflection gain analysis (e.g., performed in method 700); signals from sources that are not omnidirectional may result in inaccurate reverb gain or reflection gain determination.

In some embodiments, determining whether the omnidirectional constraint is met comprises determining whether a radiation pattern of a source of the signal is known or presumed. In some embodiments, the source radiation pattern is known or may be deduced (e.g., based on information about the source from information about the environment, the orientation of the source is known or may be detected), and the omnidirectional constraint may be relaxed because an uncertainty associated with an unknown directionality is reduced. In some embodiments, to better meet the omnidirectional constraint, a source radiation pattern of the signal is required to be known or may be deduced (e.g., based on information about the source from information about the environment).

In some embodiments, determining whether the omnidirectional constraint is met comprises comparing between microphone inputs. For example, the signal is received via more than one microphone (e.g., more than one of microphone 250; microphones 250A, 250B, 250C, and 250D; microphone of handheld controller 300; microphone array 507). Levels of the signal received at each microphone may be compared, and the relative differences between the levels indicate whether the omnidirectional constraint is met (e.g., the relative differences are within a threshold value).

In some embodiments, a neural network is trained to identify known radiation patterns and orientations. For example, the neural network is trained to identify sounds such as a signal generated by a user (e.g., a user's voice, hand-clap, snap, pop, and the likes). In some embodiments, VAD (e.g., DeepVAD) is used to identify user speech for determining whether a radiation pattern and orientation is known. For example, the VAD identifies the user's speech, and in accordance with this identification, the signal is determined to have a known radiation pattern and orientation. In some embodiments, in accordance with a determination that the signal has a known radiation pattern and orientation, the signal is determined to meet the omnidirectional constraint.

In some embodiments, determining whether the impulse signal constraint is met comprises determining whether the signal comprises an impulse signal. In some embodiments, determining whether the signal comprises an impulse signal comprises determining whether the signal comprises one or more of an instantaneous signal, an impulse signal, and a transient signal. For example, the instantaneous, impulsive, or transient signal comprises a short duration (e.g., shorter than a threshold amount of time, shorter than 10 ms) of energy above a threshold level (e.g., an energy level meeting the minimum SNR constraint).

In some embodiments, confirming that the signal comprises an instantaneous, impulsive, or transient signal ensures the accuracy of reverb gain or reflection gain analysis (e.g., performed in method 700); a signal that does not comprise an instantaneous, impulsive, or transient signal may result in inaccurate reverb gain or reflection gain determination. That is, the instantaneous, impulsive, or transient signal may comprise wide spectral components, allowing a wide frequency range to be analyzed and a wide frequency response (e.g., corresponding to environmental mapping, environmental reverberation/reflection, acoustic environment fingerprint) to be derived (e.g., using method 700).

In some embodiments, determining whether the impulse signal constraint is met comprises applying a dual envelope follower based on the signal. For example, two envelope followers at different time scales (e.g., a first envelope follower at a shorter time scale and a second envelope follower at a longer time scale) are momentarily compared to identify fast onsets (e.g., beginning of a signal) and offsets (e.g., end of a signal) of a signal (e.g., fast enough to qualify the signal as meeting the impulse signal constraint). If the difference between the first envelope follower at the short time scale is higher than the second envelope follower at the longer time scale by a threshold amount, then a fast onset is determined. If the difference between the second envelope follower at the longer time scale is more negative than the first envelope follower at the shorter time scale by a threshold amount, then a fast offset is determined. If a fast onset and a fast offset are determined for a signal, and the fast onset and the fast offset occur within a short duration of time (e.g., shorter than a threshold amount of time, shorter than 10 ms), then the signal is determined to meet the impulse signal constraint.

In some embodiments, techniques for identifying transient signals, such as those used by perceptual audio codecs (e.g., perceptual entropy, spectral analysis), are used to determine whether the impulse signal constraint.

In some embodiments, in accordance with a determination that the signal meets the impulse constraint, a first analysis is performed on the signal. For example, in accordance with the determination that the signal meets the impulse constraint, the first analysis, described with respect to method 700, is performed on the signal.

In some embodiments, in accordance with a determination that the impulse constraint is not met, a second analysis is performed on the signal. In some embodiments, the second analysis comprises converting the signal (e.g., received from step 602) into a clean input stream. For example, converting the signal into the clean input stream comprises converting the signal into a dry signal (e.g., a clean user voice input stream, an isolated input stream (e.g., user voice input stream)). As another example, converting the signal into the clean input stream comprises converting the signal into direct sound energy (e.g., energy corresponding to the sound of the signal itself).

By converting the signal into a clean input stream, an amount of acoustic energy associated with the signal (e.g., an amount of acoustic energy injected into the environment) may be computed. And by computing the amount of acoustic energy, the acoustic energy may be tracked, and decay time and/or reverb gain may be solved (e.g., solved iteratively) by matching the clean input stream with the signal. For example, by matching the clean input stream with the signal, a difference between the clean input stream and the signal may be determined, and the difference may allow the decay time and/or reverb gain to be derived (e.g., the difference is a function of decay time and/or reverb gain).

As an example, reverb gain may be defined by a ratio of power returned (e.g., due to an environment's reverberation characteristics) to power radiated (e.g., power of the signal outputted by the source, power of the clean input stream). In some embodiments, the power returned is measured by detecting a returned signal at a location of the signal source. For example, the power returned is measured by a receiving device (e.g., using microphone 250; microphones 250A, 250B, 250C, and 250D; microphone of handheld controller 300; microphone array 507) at the signal source location.

In some embodiments, the power returned and the power radiated may be determined by time windowing of a detected signal (e.g., a microphone signal). In some embodiments, time windowing of the detected signal comprises detecting percussive (e.g., a user's short utterances) source sounds. For example, VAD (e.g., DeepVAD) may be used to detect a presence of a voice input. Once the presence of a voice input is detected, occurrences of short utterances from the user are determined. For example, the short utterance has a short enough duration such that the utterance does not interfere with detecting of the returned signal (e.g., for determining reverberation properties of the environment). As another example, a short utterance has a duration shorter than a threshold amount of time.

In some embodiments, a plurality of returned and radiated signals are measured, and the power returned to power radiate ratios are computed for the corresponding signals. The computed ratios may cumulated to map the audio response of the environment (e.g., reverberation/reflection of the environment, acoustic environment fingerprint of the environment). In some embodiments, the different computed ratios allow audio responses for different frequency ranges to be determined and compiled together into a response representative of the entire signal. In some embodiments, the cumulating of the ratios advantageously allow a non-impulsive signal to be used for mapping the audio response of the environment.

In some embodiments, the signal corresponds to sounds not generated in response to a request to map the environment (e.g., indirect sounds). For example, these sounds include sounds in the environment generated independently from the request to map the environment (e.g., sounds that are generated with or without the request to map the environment, sounds native to the environment). These sounds may be sound reflections or reverberated sounds from the environment. In some embodiments, beamforming is performed to isolate the signal. For example, beamforming is used to isolate the indirect sounds. In some embodiments, if a location of an indirect sound is known and the indirect sound is isolated, the indirect sound may be used for mapping the environment (e.g., as described with respect to method 700).

In some embodiments, the information acquired, derived, or computed during the method 600 may be used for a subsequent process or analysis (e.g., as described with respect to method 700 and/or methods described with respect to environment 800). For example, if a user's voice is identified as a signal source (e.g., using VAD or other methods described herein), it is determined that the signal has a known radiation pattern and/or orientation. In some embodiments, a subsequent process or analysis may be tuned to account for characteristics (e.g., timing and/or frequency response corresponding to a human speaker, timing and/or frequency response corresponding to a gender, other timing and/or frequency responses) of the voice determine during its identification.

Because a radiation pattern of a source determines an amount of energy transmitted from a source to a medium, knowing the source's radiation pattern and orientation the omnidirectional constraint may be satisfied. For example, the omnidirectional constraint may be satisfied by compensating for direct path attenuation and/or energy radiation into an environment. For example, the attenuation, loss, etc. may be compensated by a source's energy transmission characteristics determined from the known the radiation pattern and/or orientation.

In some embodiments, reverb gain computation (as described in more detail herein) is a comparison between direct path attenuation and energy radiation into an environment. By performing the compensation, the reverb gain may be more accurately computed.

More generally, in some embodiments, in accordance with a determination that the requirement for analysis is not met (e.g., based on step 604), compensation is applied (e.g., to the signal, by deriving additional constraint-related information associated with the signal). In some embodiments, compensation is applied to improve accuracy of subsequent processing or analysis (e.g., as described with respect to method 700 and methods described with respect to environment 800). In some embodiments, compensation is applied to allow the compensated signal to meet the requirement for analysis (e.g., the compensated signal meets a constraint after compensation).

As another example of information acquired, derived, or computed during the method 600 that may be used for a subsequent process or analysis, a distance to a source may be determined via signal analysis (e.g., derived based on an attenuation of a received signal). The attenuation may be used in reverb gain computation (as described in more detail herein). In some embodiments, because the distance to the source is determined and known, a corresponding collocation constraint may be relaxed because an uncertainty of whether the source is collocated is reduced.

In some embodiments, by determining whether the disclosed constraints or requirements are met and whether the signal is suitable for subsequent analysis, the method 600 may advantageously eliminate the need for real-time data (e.g., real-time sensor data from the receiving device) for environmental mapping. For example, it is determined that the signal comprises sufficient information for derivation of environmental mapping information (e.g., environmental reverb/reflection, acoustic environment fingerprint). Because the signal comprises sufficient information for deriving environmental mapping, no additional real-time data may be necessary, and the environmental mapping analysis may be performed at a different time and/or on a different device with examples and advantages described herein.

FIG. 6B illustrates an exemplary method 650 of determining signals to be analyzed according to some embodiments of the disclosure. In some embodiments, the method 650 determines whether a signal is to be analyzed in method 700. For example, the method 650 determines whether a signal comprises characteristics for a device or a system to extract mapping information (e.g., reverberation/reflection, acoustic environment fingerprint of the environment) about an environment of the signal (e.g., an audio signal recorded in an AR, MR, or XR environment). In some embodiments, the signal comprises one or more input streams received in real time and the determination of whether the signal should be captured for analysis (e.g., performed in method 700) is also determined in real time.

Although the method 650 is illustrated as including the described steps, it is understood that a different order of steps, additional steps, or fewer steps may be included without departing from the scope of the disclosure. For example, steps of method 650 may be performed with steps of other disclosed methods (e.g., method 600, method 700, methods described with respect to environment 800). As another example, the method 650 may determine that a signal is to be analyzed based on fewer requirements than described. As yet another example, the method 650 may determine that a signal is to be analyzed based on other requirements than described.

In some embodiments, computation, determination, calculation, or derivation steps of method 650 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR, MR, or XR system and/or using a server (e.g., in the cloud).

In some embodiments, the method 650 includes receiving a block of samples (step 652). For example, step 602 described with respect to method 600 is performed. For the sake of brevity, examples and advantages of this step are not described here.

In some embodiments, the method 650 includes smoothing the block of samples into an envelope (step 654). For example, as described with respect to the minimal SNR constraint herein, a block of samples is smoothed into an RMS envelope. For the sake of brevity, examples and advantages of this step are not described here.

In some embodiments, the method 650 includes line-fitting the envelope (step 656). For example, as described with respect to the minimal SNR constraint, a line is fitted against the RMS envelope. For the sake of brevity, examples and advantages of this step are not described here.

In some embodiments, the method 650 includes determining whether to collect the block of samples (step 658). For example, the receiving device (e.g., wearable head device 200A, wearable head device 200B, handheld controller 300, wearable system 501A, wearable system 501B, a server) determines whether to collect the block of sample or a portion of the block of samples (e.g., in response to receiving an input from the user, from an application).

In some embodiments, in accordance with a determination to not collect the block of samples, the method 650 includes comparing the envelope with a SNR threshold (step 660). For example, the RMS envelope (e.g., the fitted line, the envelope average) is compared with an SNR on threshold (e.g., a threshold dB above the noise floor). In some embodiments, if the RMS envelope is greater than the SNR on threshold, then the block of samples is determined to meet the minimal SNR constraint.

In some embodiments, in accordance with a determination that the envelope (e.g., average of the block envelope) is not greater than the on threshold, the method 650 includes determining whether the fitted line is flat (step 662). For example, the slope of the fitted line may be compared with a threshold slope, if the slope of the fitted line is below the threshold slope, then the fitted line is determined to be flat. In accordance with a determination that the fitted line is not flat (e.g., the block of sample is not flat and the minimal SNR constraint is not met), the method 650 may be completed until a new block of samples is received.

In some embodiments, in accordance with a determination that the fitted line is flat, the method 650 includes determining a value of the fitted line (step 664). For example, an average of the fitted line is determined. If the value of the fitted line is below the noise floor (e.g., the block of sample may comprise noise because it is flat and is below the on threshold), then the method 650 includes moving the noise floor down (step 666). In some embodiments, the noise floor is moved down quickly to quickly converge to a new noise floor. If the value of the fitted line is above the noise floor, then the method 650 includes moving the noise floor up (step 668). In some embodiments, the noise floor is moved up slowly to prevent the new noise floor from being analyzed for environmental mapping (as described with respect to the minimal SNR constraint).

In some embodiments, in accordance with the determination that the envelope (e.g., average of the block envelope) is greater than the on threshold, the method 650 includes updating analysis conditions and determining to collect the block of samples (step 670). For example, while it was determined to not collect the block of samples, it is determined that the block of samples meets the minimal SNR constraint. Therefore, in some embodiments, the analysis conditions are updated to change the determination to collect the block of sample (e.g., to step 672).

In some embodiments, in accordance with a determination to collect the block of samples, the method 650 includes comparing the envelope with a SNR threshold (step 672). For example, the RMS envelope (e.g., the fitted line, the envelope average) is compared with an SNR off threshold (e.g., a threshold dB above the noise floor). In some embodiments, if the RMS envelope is less than the SNR off threshold, then the block of samples is determined to not meet the minimal SNR constraint.

In some embodiments, in accordance with a determination that the envelope is less than the SNR threshold (e.g., the block of samples does not appear to meet the minimal SNR constraint), the method 650 includes comparing a slope of the envelope with a threshold slope (step 674). For example, the slope of the fitted line is compared with the threshold slope.

In some embodiments, in accordance with a determination that the slope is less than the threshold slope, the method 650 includes continuing to collect samples (step 676). For example, it is determined that the collected samples do not meet the minimal SNR constraint and does not have a sufficiently high slope, the method 650 may continue to collect samples until a sample meets the minimal SNR constraint (e.g., for further processing to determine whether the block of samples may be used for environmental mapping).

In some embodiments, in accordance with a determination that the slope is greater than the threshold slope, the method 650 includes stopping to collect samples (step 678). For example, although the envelope may be less than the SNR threshold, the block of samples has a sufficiently high slope (e.g., such that a portion of the block of samples may meet the minimal SNR constraint). In some embodiments, in accordance with a determination that the envelope is greater than the SNR threshold (e.g., from step 672, the block of samples meets the minimal SNR constraint), the method 650 includes stopping to collect samples (step 678). In some embodiments, sample collection is stopped, and the collected samples are further processed (e.g., to determine whether the block of samples may be used for environmental mapping).

In some embodiments, the method 650 includes determining whether a collocation constraint is met (step 680). For example, as described with respect to the collocation constraint herein, whether the collected samples meet the collocation constraint is determined. For the sake of brevity, examples and advantages of this step are not described here. In some embodiments, step 680 is performed in accordance with a determination that the collected samples meet a minimum SNR constraint. In some embodiments, in accordance with a determination that the collocation constraint is not met, the method 650 may be completed until a new block of samples is received.

In some embodiments, the method 650 includes determining whether an omnidirectional constraint is met (step 682). For example, as described with respect to the omnidirectional constraint herein, whether the collected samples meet the omnidirectional constraint is determined. For the sake of brevity, examples and advantages of this step are not described here. In some embodiments, step 682 is performed in accordance with a determination that the collected samples meet a collocation constraint. In some embodiments, in accordance with a determination that the omnidirectional constraint is not met, the method 650 may be completed until a new block of samples is received.

In some embodiments, the method 650 includes determining whether an impulse constraint is met (step 684). For example, as described with respect to the impulse constraint herein, whether the collected samples meet the impulse constraint is determined. For the sake of brevity, examples and advantages of this step are not described here. In some embodiments, step 684 is performed in accordance with a determination that the collected samples meet an omnidirectional constraint. In some embodiments, in accordance with a determination that the impulse constraint is not met, the method 650 may be completed until a new block of samples is received.

In some embodiments, in accordance with the determination that the requirements or constraints have been met, the collected samples may be subjected to further analysis. For example, it is determined that the collected samples meet one or more of the disclosed constraint (e.g., minimal SNR, duration, collocation, omnidirectional, impulse). In accordance with this determination, the collected samples are determined to be suitable for analysis for environmental mapping (e.g., the collected samples comprise information that would yield accurate derivation of environmental reverberation/reflection and/or acoustic environment fingerprint). In some embodiments, these collected samples are processed using method 700.

In some embodiments, by determining whether the disclosed constraints or requirements are met and whether the signal is suitable for subsequent analysis, the method 650 may advantageously eliminate the need for real-time data (e.g., real-time sensor data from the receiving device) for environmental mapping. For example, it is determined that the signal comprises sufficient information for derivation of environmental mapping information (e.g., environmental reverb/reflection, acoustic environment fingerprint). Because the signal comprises sufficient information for deriving environmental mapping, no additional real-time data may be necessary, and the environmental mapping analysis may be performed at a different time and/or on a different device with examples and advantages described herein.

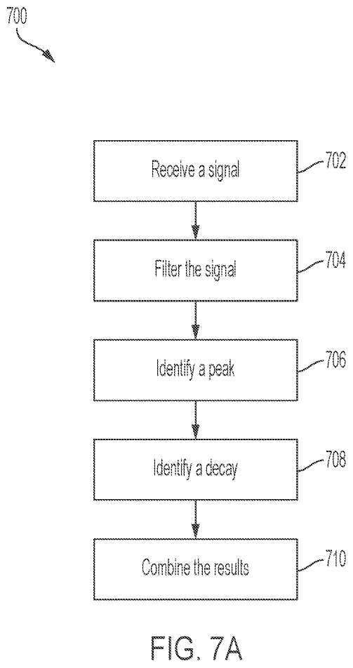

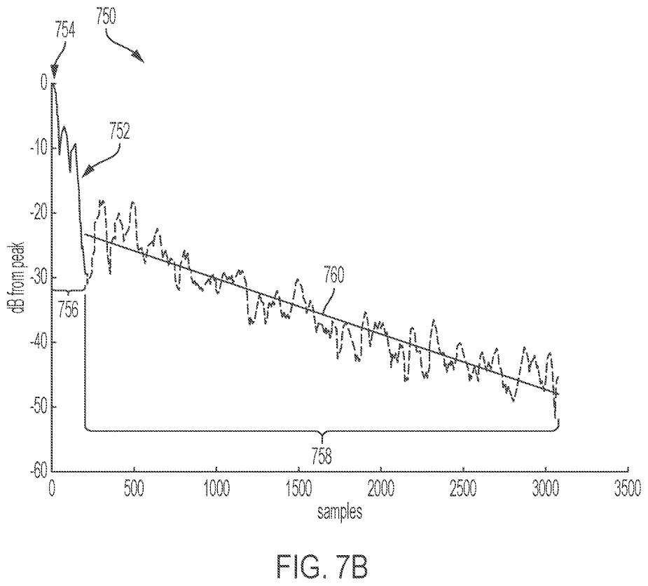

FIG. 7A illustrates an exemplary method 700 of signal analysis according to some embodiments of the disclosure. In some embodiments, the method 600 or method 650 determines whether a signal is to be analyzed in method 700. For example, the method 700 comprises analyzing a signal (e.g., determined from method 600 or 650) for mapping information (e.g., reverberation/reflection; acoustic environment fingerprint, which is a collection of audio properties (e.g., frequency-dependent decay time, reverb gain, reverb decay time, reverb decay time low-frequency ratio, reverb decay time high-frequency ratio, reverb delay, reflection gain, reflection delay) of the environment).

In some embodiments, because real-time data may not be required to perform the analysis (e.g., real-time sensor data are not required for environmental mapping), the method 700 (e.g., determination of reverberation/reflection properties or acoustic environment fingerprint of the AR, MR, or XR environment based on a signal) is performed offline. Performing the analysis offline may allow application of advantageous signal processing techniques such as non-causal, zero-phase FIR filtering, or other more optimized techniques because the analysis may not need to be completed in real-time. In some embodiments, by performing the analysis offline, the analysis may advantageously be performed with a device other than the receiving device (e.g., the device receiving the samples). The other device (e.g., a server, the cloud, a remote computing resource) may be a more efficient or powerful device that may be more suitable for performing this analysis. Furthermore, performing the analysis at a different time and/or at a different device may free up computing resources from the receiving device, allowing the receiving device to run more efficiently.

In some embodiments, the disclosed methods and systems advantageously allow determination of reverberation properties of an unknown space using analysis of only audio signals detected by a receiving device and other known information (e.g., without additional data from other sensors).

Although the method 700 is illustrated as including the described steps, it is understood that a different order of steps, additional steps, or fewer steps may be included without departing from the scope of the disclosure. For example, steps of method 700 may be performed with steps of other disclosed methods (e.g., method 600, method 650, methods described with respect to environment 800).

In some embodiments, computation, determination, calculation, or derivation steps of method 700 are performed using a processor (e.g., processor of IR system 112, processor of wearable head device 200A, processor of wearable head device 200B, processor of handheld controller 300, processor of auxiliary unit 400, processor 516, DSP 522) of a wearable head device or an AR, MIR, or XR system and/or using a server (e.g., in the cloud).

In some embodiments, generally, the method 700 includes determining a decay time and computing a reverb gain for environmental mapping (e.g., environmental reverb/reflection, acoustic environment fingerprint). For example, the decay time may be determined by measuring the “t60” time of a signal being analyzed (e.g., a block of samples or collected samples that are deemed suitable for environmental mapping analysis (e.g., from method 600 or 650)) or the time to decay by 60 dB. The t60 time may be measured by fitting a smoothed envelope representing the signal between a measured peak and a known or a measured noise floor.

By using the disclosed methods to determine the decay time, energy “ringing” is reduced, compared to using a running energy envelope by applying a short-order filter to the signal with coefficients based on smoothing time constants. In contrast, in some embodiments, the disclosed analysis methods use an RMS envelope smoothing method. For example, smoothing is accomplished by taking a square root of the arithmetic mean of the squared values of the signal (e.g., within a duration defined by a specified time constant around a sample). Using the RMS envelope smoothing method, the generated envelope is more uniform for direct analysis. As a result, decay and gain measurement accuracies are improved. In some embodiments, using RMS envelope smoothing results in a more efficient analysis.

Furthermore, in some embodiments, the disclosed envelope smoothing method may be applied to a frequency band of interest (e.g., separated using the disclosed filtering steps), compared to smoothing a larger frequency band. As a result, amplitude modulation due to aliasing effects may be reduced.

In some embodiments, the disclosed environmental mapping analysis includes performing a linear fit on an RMS-smoothed energy envelope. A correct range of envelope for fitting may affect the accuracy of the mapping. For example, the energy envelope may ideally follow an impulsive sound after early reflections arrive (e.g., the beginning of the envelope is a free-decay region of exponential energy decay). Therefore, in some embodiments, regions of the signal that are more likely to be a part of a decay region is fitted for measuring decay. In some embodiments, the decay region and a peak are fitted. To reduce the processing, the fitted peak may be used for reverb gain computation without additional copying or processing of samples.

Reverb gain may be computed by extrapolating a decay line fit (e.g., in logarithmic space) to an identified peak or impulse time, and comparing relative level between the extrapolated points and the peak level. In some embodiments, enforcing the collocation and/or the omnidirectional constraint (e.g., described with respect to method 600 or 650) advantageously allows this computation to be more efficient because meeting the constraint(s) reduces terms (e.g., terms corresponding to distance attenuation, orientation attenuation, and/or radiation pattern in the reverb gain calculation may be simplified or disregarded) in the calculation and allows a more straight-forward computation in magnitude-space. For example, if the constraints are met, reverb gain (in dB)=peak gain (in dB)—decay line fit gain at peak (in dB).

In some embodiments, the method 700 includes receiving a signal (step 702). For example, the analysis device (e.g., wearable head device 200A, wearable head device 200B, handheld controller 300, wearable system 501A, wearable system 501B, a server) receives a block of samples or collected samples that are deemed suitable for environmental mapping analysis (e.g., from method 600 or 650).

In some embodiments, the method 700 includes filtering the signal (step 704). In some embodiments, filtering the signal comprising filtering the signal into frequency sub-bands (e.g., low, mid, high frequency sub-bands). For example, a FIR non-causal, zero-phase filter bank is applied to the signal to separate the signal into sub-bands. In some embodiments, a FIR non-causal quadrature mirror filter (QMF) is used in a resampling filter bank configuration to maximize preservation of timing between sub-bands. In some embodiments, the parameters of the filter, such as order, pass band ripple, and stop band rejection, are user defined, system defined, or dynamically determined.

In some embodiments, each of the sub-bands is obtained from an output of a high-pass portion of the QMF. An output of a low-pass portion of the QMF may be down-sampled by a factor (e.g., 2) and inputted to the QMF again to produce a band one octave below a previous band. This process may be repeated until a desired number of octave band is reached or a minimal number of samples remain for performing the analysis. In some embodiments, each sub-band has a suitable corresponding down-sampling rate.

In some embodiments, the number of sub-bands is greater than a number of expected decay time control points. This number of sub-bands advantageously increase the robustness of the analysis (e.g., suitable for larger analyses) and improve an understanding (e.g., increases a resolution) of an audio response of the environment, allowing further refinement of the derived audio response and/or other signal processing or propagation components. In some embodiments, the decay time control points are determined by averaging, line-fitting, or curve-fitting some or all of the frequency band results. In some embodiments, outliers or extreme values, such as those less than zero, are rejected. In some embodiments, the number of sub-bands sufficiently fills an audible spectrum. In some embodiments, prior to analysis of each sub-band, the energy of each sub-band is determined, to ensure that each sub-band comprises sufficient energy.

In some embodiments, each sub-band is individually analyzed. As described in more detail herein, after environmental mapping information is analyzed for each sub-band, the results for all the sub-bands may be combined together to compile mapping information for a measurement (and the measurement may be combined with other measurements of the environment, as described with respect to environment 800). As discussed, the disclosed methods advantageously allow the FIR non-causal, zero-phase filter to be applied to the signal and sub-bands of the signal to be individually, more efficiently, and more accurately analyzed.

In some embodiments, the method 700 includes identifying a peak (step 706). For example, a peak is identified by local minima of a first derivative of the signal (e.g., a non-smoothed signal, an enveloped signal) in a sub-band. As another example, the peaks are identified by portions of the first derivative of the signal (e.g., a non-smoothed signal, an enveloped signal) below a threshold value. That is, in some embodiments, the method 700 searches for “quick drops” in energy for each sub-band to identify potential regions of interest by searching for local minima or portions below a threshold value in the first derivative of the signal. Identifying these “quick drops” may identify the peaks of a signal for each sub-band because these “quick drops” may occur around a peak (e.g., after the peak) (e.g., the sharper the drop, the more impulsive the signal). For example, a peak may be identified before an identified “quick drop.”

In some embodiments, a dual-envelope tracker is used to determine whether an impulse constraint is met (e.g., from method 600 or 650). The dual-envelope tracker may also be used to search for portions of the signal corresponding to a rapid drop in energy. For the sake of brevity, examples and advantages are not described herein.

In some embodiments, the method 700 includes identifying a decay (step 708). For example, from the identified peak for a sub-band, the peak may be intersected with a line-fit to determine a reverb gain and/or decay time. In some embodiments, steps 706 and 708 are performed for the different sub-bands.

In some embodiments, subset of samples within a region between peaks and a noise floor are selected to reject. The rejected samples may more likely comprise early reflections or other characteristics inconsistent with the audio response of the environment (e.g., likely to contaminate decay time measurement). For example, from the peak, a number of samples that may correspond to early reflections are skipped and not used for line-fitting. In some embodiments, the number of skipped samples is determined using auto-correlation reflections analysis, measured reverb delay, or room geometry information. The collected samples may be line-fitted after the skipped samples.

In some embodiments, the skipped samples (e.g., samples at a sound tail) are analyzed. For example, the skipped samples are analyzed to determine other properties of an acoustic environment fingerprint, such as reflection gain and/or reflection delay. Analyzing skipped samples corresponding to reflections may allow cross-correlation and other techniques described herein.

FIG. 7B illustrates an exemplary method of signal analysis according to some embodiments of the disclosure. Specifically, FIG. 7B illustrates an example of identifying a peak from the signal 750, identifying samples to skip, and line-fitting the appropriate samples of signal 750. In some embodiments, the signal 750 is an average-smoothed RMS signal corresponding to a sub-band, as described herein, and the signal comprises a collection of samples.

In this example, as described with respect to step 706, a “quick drop” 752 is identified. Because a “quick drop” is identified, a peak 754 may be identified by searching a region before the “quick drop.” The region for searching for the peak before the “quick drop” may be dynamically determined, system defined, or user defined. As described with respect to step 708, a number of samples (e.g., samples that may correspond to early reflection) is skipped. The skipped samples correspond to region 756 of the signal 750. The region 756 may be dynamically determined, system defined, or user defined.

After the skipped samples, a decay slope in the region 758 of the signal 750 is fitted (e.g., linearly fitted) with line 760. In some embodiments, the region 758 ends (e.g., the end of the fitted line) at a SNR threshold (e.g., a threshold amount above the noise floor). In some embodiments, the region 758 ends at a predetermined time (e.g., a width of the region 758 is a predetermined amount of time, a maximum number of predetermined samples, an amount of time before the region 758 reaches the noise floor, when a sufficient amount of samples is obtained for computation before reaching the noise floor). In some embodiments, the region 758 ends (e.g., the end of the fitted line) when the signal 750 rises upward (e.g., indicating a new signal, indicating a new peak). The fitted line 760 is used to compute the reverb decay time of signal 750 for environmental mapping. In some embodiments, the fitted line 760 is used to compute the t60 time based on the slope of the fitted line 760.

Returning to FIG. 7A, in some embodiments, the method 700 includes combining analysis results for different bands (step 710). For example, after reverb decay time, reverb gain, reflection gain, and/or reflection delay are computed for each sub-band (e.g., as described above), the results are combined into a set of results representative of an audio response of the environment (e.g., environmental reverberation/reflection, acoustic environment fingerprint) corresponding to a location of the signal.

In some embodiments, the results are combined by fitting a line through the results from the different sub-bands and sampling points corresponding to center frequencies of the respective sub-bands (e.g., low, mid, high sub-bands). In some embodiments, in order to fit the line through the sampling points, the decays for each sub-band are substantially linear. In some embodiments, to improve accuracy, a non-linear line is used to fit between the results from different sub-bands.

In some embodiments, results from different sub-bands are weighted based on different factors. For example, the results from different sub-bands may be weighted based on an overall energy present in a corresponding sub-band. As another example, the results from different sub-bands may be based on an SNR (e.g., a maximum SNR) of a corresponding sub-band. In some embodiments, based on the weights, a result from a sub-band may not be included in the combined analysis results.

In some embodiments, the signal is analyzed for environmental mapping by deconvolving the signal (e.g., in lieu of method 700). For example, the signal is an omnidirectional signal, and the omnidirectional signal is deconvolved with a direct path signal (e.g., from an impulsive source, isolated from the omnidirectional signal). The direct path signal may be isolated by performing beamforming, auto-correlation, or cepstrum analysis.

After the deconvolution, the remaining signal may correspond to an audio response of the environment. From the remaining signal, environmental mapping information (e.g., environmental reverb/reflection, acoustic environment fingerprint) may be determined (e.g., using known analysis methods). In some embodiments, a higher bandwidth spatial reverberation system may use the determined environmental mapping information to apply reverb to a signal in the environment. For example, using a convolution-based reverb and interpolating distance from a listener, the environmental audio response positions and/or orientations are detected to generate a continuously updating audio response (e.g., for the convolution).

In some embodiments, a known signal (e.g., an impulse signal) using a detected device (e.g., a detected device (e.g., information associated with the device, such as radiation, spectral output, orientation, position, location, and distance, may be obtained over a wireless network) other than the receiving device at a known location of the environment) is played. In some embodiments, the detect device (e.g., a speaker) is configured to produce enough energy to drive the environment. The signal for analysis is deconvolved with the known signal, and an audio response of the environment is derived. In some embodiments, based on the information associated with the device, the known signal may be compensated to generate a more impulse-like signal for a more accurate derived audio response. In some embodiments, the signal to be analyzed is provided (e.g., via a wireless connection) by the detected device.

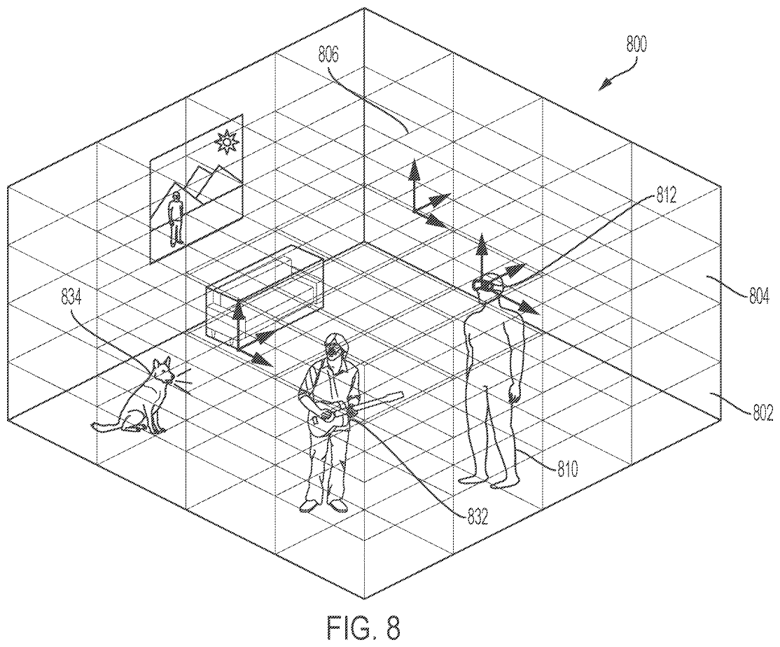

FIG. 8 illustrates an exemplary environment 800 according to some embodiments of the disclosure. For example, environment 800 is MRE 150, as described with respect to FIGS. 1A-1C. User 810 may correspond to user 110, MR system 812 may correspond to MR system 112 or an AR, MR, or XR system disclosed herein, and virtual character 832 may correspond to virtual character 132. As illustrated, virtual dog 834 may be a part of the environment 800. It is understood the geometry of the environment 800 is meant to be limiting. The disclosed methods and systems may be configured to map environments having other geometries.

The disclosed methods and systems may provide the user 810 an immersive AR, MR, or XR experience by providing a realistic audio response to virtual sound sources, in contrast to providing a “dry” audio signal that may confuse a listener. For example, when virtual character 832 plays the acoustic guitar, the sound of the acoustic guitar is presented to the user 810 according to the mapping of the environment 800 (e.g., environment reverb/reflection, acoustic environment fingerprint), using the disclosed methods and systems. As another example, when virtual dog 834 barks, the sound of the bark is presented to the user according to the mapping of the environment 800. The disclosed methods and systems may additionally more efficiently provide the realistic audio response to the virtual sound sources.

In some embodiments, computation, determination, calculation, or derivation steps described with respect to environment 800 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR, MR, or XR system and/or using a server (e.g., in the cloud).

In some embodiments, the environment 800 has an associated three-dimensional map of audio properties throughout an environment based on the analyses of signals (e.g., using method 700 to obtain reverb decay time, reflection delay, and reverb/reflection gain measurements). In some embodiments, the disclosed methods and systems efficiently manage a plurality of measurements for different uses and environment conditions. In some embodiments, the disclosed methods and systems allow association and consolidation of individual measurements (e.g., reverb decay time, reflection delay, reverb/reflection gain) and sharing measurements of the environment between different devices.

In some embodiments, a plurality of analyzed signals (e.g., signals analyzed using method 700 to determine environmental mapping information) are combined to form a combined environmental mapping of environment 800. For example, a first and a second signal of the environment may be analyzed to determine corresponding reverberation properties (e.g., reverb decay time, reflection delay, reverb/reflection gain). The reverberation properties may be combined together to form a combined environmental mapping, which may represent a more accurate audio response of the environment.

In some embodiments, the first signal is analyzed on a first device (e.g., a first analysis device, a server), and the second signal (e.g., a second analysis device, a server) is analyzed on a second device. In some embodiments, the first signal is analyzed at a first time, and the second signal is analyzed at a second time. For instance, the second signal may be analyzed at a later time than the first signal. The analysis of the second signal updates the audio response of the environment 800 (e.g., stored in a server) and improves the accuracy of the audio response (e.g., for a more immersive and realistic AR, MR, or XR audio environment for future users in the environment).

In some embodiments, conditions under which a measure may be requested are determined, based on spatial and temporal proximity of previous measurements and/or other factors. In some embodiments, additional data to facilitate access, curation, and association of the reverb decay time, reflection delay, and reverb/reflection gain measurements for mapping an environment are considered.

In some embodiments, different locations of the environment 800 are associated with different audio response properties. For example, portions of an audio mapping of the AR, MR, or XR environment are associated to voxels 802 (e.g., uniform size voxels, non-uniform size voxels). The size of a voxel may be the resolution of the map of the environment (e.g., reverberation properties as a function of a location in the environment). Each portion may comprise a set of environmental properties (e.g., audio responses, reverberation/reflection, acoustic environment fingerprint) associated with a location of a respective voxel. These properties may correspond to a fixed point in each voxel (e.g., the center point of a voxel), and a same set of properties may correspond to a volume of a voxel about this fixed point. The set of properties associated with each voxel may be determined based a signal processed and analyzed using method 600, 650, and/or 700.

For example, voxel 802A (not illustrated) corresponds to the location of the MR system 812, and virtual audio presented to the user 810 via the MR system 812 is based on the properties associated with voxel 802A. The properties associated with voxel 802A may determine how virtual character 832's acoustic guitar playing is presented to the user 810 (e.g., how reverb is applied to the acoustic guitar sounds). The properties associated with voxel 802A may also determine how virtual dog 834's barking is presented to the user 810 (e.g., how reverb is applied to the barking sounds).

Additionally, associating measurements or properties to voxels allows for more scalable environmental mapping. For example, the voxel may be a basic building block of an environment map. The pluralities of voxels may form different geometric zones associated with different acoustic responses, and the association by voxel allows the different zones to be seamlessly interconnected (e.g., to support multi-room simulation). A spatial audio system (e.g., wearable head device 200A, wearable head device 200B, handheld controller 300, wearable system 501A, wearable system 501B) may receive the environmental mapping information (e.g., associated and generated using the methods and systems described herein) and respond according to a current voxel at the system's position and corresponding geometric zone.

In some embodiments, a set of properties associated with a voxel is computed. For example, for a particular voxel, a set of reverb properties is computed based on audio response measurements (e.g., reverb decay times, reflection delay, and/or reverb/reflection gains obtained from method 700). The set of reverb properties may be obtained by applying weights to the response measurements to adjust for differences between the measurement and the voxel (e.g., location differences between the measurement and the voxel, time differences between the measurement and a current time).

In some embodiments, the set of properties includes metadata in addition to the reverb properties. For example, the metadata includes first measurement, time stamp, position, and confidence. In some embodiments, the first measurement metadata indicates that the corresponding voxel's properties have not been set.

In some embodiments, the time stamp metadata indicates an age of an audio response property. In some embodiments, measurements with an older time stamp are weighted less, and measurements with a newer time stamp are weighted more (e.g., the newer measurements may be a more accurate representation of the acoustic response of the environment). In some embodiments, if a measurement is older than a threshold age, the property is removed (e.g., no longer considered in determining a combined response of the environment).

In some embodiments, the position metadata is derived from a receiving device (e.g., the device receiving a signal for determining decay time, reflection delay time, and/or reverb/reflection gain of the environment, as described with respect to method 600, 650, or 700). For example, while a signal is received, metadata including position information of the receiving device (e.g., determined using a sensor of the receiving device) is associated with the received signal. The position information may include coordinates of the received signal.

In some embodiments, the position metadata determines an amount of weight applied to a measurement in its contribution to a property. For example, if a voxel is more proximal to a location of a measurement (e.g., as indicated by the position metadata), then a corresponding distance weight for the measurement would be higher (e.g., proportional to the distance between the voxel and the position of the measurement). As another example, if a voxel is more distant to a location of a measurement (e.g., as indicated by the position metadata), then a corresponding distance weight for the measurement would be lower (e.g., proportional to the distance between the voxel and the position of the measurement). In some embodiments, if a voxel is beyond a maximum distance, the measurement would have no corresponding distance weight (e.g., the measurement was made too far from the voxel to affect the acoustic response at the voxel). In some embodiments, if a voxel is within a minimum distance, the measurement would have a full distance weight.

As an example, a measurement was made at location 804 (e.g., the signal received for deriving this measurement was received at location 804) of the environment 800, and the properties associated with the voxel 802A depend on a weighted version of the measurement (determination of the weights are described in more detail herein). If the location 804 is within a minimum distance from the voxel 802A, then the measurement is given full weight for determining the properties (e.g., audio response, reverberation/reflection response, acoustic environment fingerprint) associated with the voxel 802A. If the location 804 is between a minimum distance and a maximum distance from the voxel 802A, then the measurement is given a proportional weight for determining the properties (e.g., audio response, reverberation/reflection response, acoustic environment fingerprint) associated with the voxel 802A. If the location 804 is beyond a maximum distance from the voxel 802A, then the measurement is given no weight for determining the properties (e.g., audio response, reverberation/reflection response, acoustic environment fingerprint) associated with the voxel 802A.

As another example, reverberation properties may affect the distance weight. For example, a longer decay time may increase minimum and maximum distances (e.g., corresponding to the minimum and maximum distances described above). For example, if a voxel is within a maximum distance of the measurement, then the measurement affects a property associated with the voxel, as scaled by the weight. If a voxel is within a minimum distance of the measurement, then the measurement's effect on the property associated with the voxel is scaled by a full weight.

In some examples, a measurement that deviates (e.g., a longer decay time) from a default set of reverb properties may be valuable to environmental mapping because the deviating measurement may provide new information about the environment and may indicate a need for non-default behavior. Addressing the need for non-default behavior may improve the perceivability of an audio response of the environment.

In some embodiments, the minimum (e.g., corresponding to full weight) and maximum (e.g., corresponding to no weight) distances depend on a state of the voxel. For example, if a voxel has a corresponding first measurement metadata (e.g., there is no measurement performed within the voxel), then the minimum and maximum distances may be increased to increase the probability of obtaining an initial measurement. After the voxel has obtained a corresponding initial measurement, the minimum and maximum distances may be reduced back to default values.

In some embodiments, the confidence metadata reflects a measurement's veracity. In some embodiments, value of the confidence metadata is determined by inspection of the measurement. For example, the decay time may be compared with an expected decay time; if the difference between the decay time and an expected value is close, then the value of the confidence metadata would be high. As another example, if the measurement comprises shorter decay time at higher frequency (which may be physically expected), then the value of the confidence metadata would be high.

In some embodiments, the confidence metadata is determined by agreement between analysis of simultaneous detections. For example, a received signal is detected by a plurality of microphones, and if computed decay times, reflection delay, and/or a reverb/reflection gains are similar using detections from the microphones, then the value of the confidence metadata would be high.

In some embodiments, measurements (e.g., decay times, reflection delay, reverb/reflection gains) may be associated to voxels. For example, a voxel is associated with a set of properties that are determined based on measurements within a maximum distance of the voxel, scaled accordingly by weights. Associating measurements to voxels may advantageously provide a way to gauge density of measurements in an environment and to determine where in the environment additional measurements may be needed, ensuring the audio response is accurate throughout the environment. For example, if the voxel corresponding to a location of the environment includes less than a threshold number of measurements (e.g. 5; measurements that are younger than an age threshold), then a new measurement process may be initiated (e.g., as described with respect to method 600, 650, or 700) (e.g., when a device is at or proximal to the location of the environment, a user is prompted to perform the new measurement at the voxel).

In some embodiments, a confidence associated with a voxel determines whether a new measurement for the voxel is needed. For example, if the sum of confidences of measurements within a voxel is less than a threshold, then a new measurement may be initiated (e.g., as described with respect to method 600, 650, or 700) (e.g., when a device is at or proximal to the location of the environment, a user is prompted to perform the new measurement at the voxel).

In some embodiments, after the new measurement is initiated, the measuring device may no longer be in the same voxel (e.g., the user moved away from the voxel during measurement). In these scenarios, the measurement would be saved and scaled accordingly (e.g., based on the differences between the first voxel and the new voxel).

In some embodiments, the number of measurements (e.g., number of measurements having a threshold confidence and/or below a threshold age) required per voxel for computing its properties depends on a size of a voxel. For example, a larger voxel may require more measurements than a smaller voxel. In some embodiments, when a sufficient amount of measurements have been obtained across the environment, the densities of measurements across the voxels are constant. In some embodiments, each voxel in the environment is associated with at least the minimum number of measurements for computing its properties. In accordance with a determination that a sufficient amount of measurements have been obtained across the environment, a device entering the environment forgoes obtaining a measurement.

In some embodiments, after a measurement is obtained, properties (e.g., reverberation properties) associated with any voxel within the maximum distance from the measurement location is recomputed (e.g., to account for this new measurement). Each affected voxel is recomputed using an appropriate weight (e.g., depending on temporal, spatial proximity, confidence value), as described herein.

As an example, a new measurement is made at location 806 (e.g., the signal received for deriving this measurement was received at location 806) of the environment 800. If the location 806 is within a maximum distance from the voxel 802A, then the new measurement would update the properties associated with the voxel 802A, according to the weights described herein.

In some embodiments, alternatively, the measurements (e.g., reverb decay time, reflection delay, reverb/reflection gain) are not associated to the voxels. A new measurement may be initiated in accordance with a determination of a measurement density (e.g., at a device location). For example, in accordance with a determination that the measurement density is below a threshold, then a new measurement process is initiated, as described herein.

In some embodiments, the determination to initiate a new measurement is made at any point in time (e.g., in response to a system command, in response to a user command). In some embodiments, the determination is made periodically (e.g., frame by frame, two measurements per meter, ten measurements every two meters) as a device navigates within the environment. In some embodiments, the determination is made when a device is beyond a threshold distance from a nearest measurement or from an average of nearest measurements. In some embodiments, the determination is made when an age measurement or average age of measurements proximal to a device is older than a threshold age. In some embodiments, the determination is made when a confidence of a measurement or a combined confidence of measurements proximal to a device is less than a threshold value. In some embodiments, one measurement request is pending at one time. That is, if a first new measurement is determined to be needed, a need for a second new measurement may not be determined until the first new measurement is completed.

In some embodiments, measurements (e.g., determined decay time, reverb gain, reflection gain, reflection time) are saved. In some embodiments, a voxel is created when a device enters a new space. For example, when a device enters a space without a voxel, a new, unset voxel (e.g., a voxel without any associated properties initially) is created. By saving the measurements, any saved measurement within a maximum distance of the new voxel may be used to provide the new voxel (e.g., based on weighting, as described herein) with properties associated with the new voxel. By providing the new voxel with saved measurements within the maximum distance, new measurements may not be required after creation of a voxel, advantageously reducing processing power and improving efficiency.

In some embodiments, a voxel is treated as a state-containing filter, the reverb properties associated with a voxel are treated collectively as samples, and the measurements as weighted samples feeding the filter. As described with respect to other examples of the voxel, the filter updates if the voxel is within a maximum distance of a measurement. After a new measurement is obtained, the coefficients of the filter updated based on weights as a function of distance and confidence, as described herein. These embodiments may not require searching of earlier measurements (e.g., to determine a weight due to time) whenever a new measurement is obtained.

In these embodiments, the measurements themselves advantageously do not need to be saved, but rather, merely the state (or the last n changes) associated with each voxel is updated. The voxel state is also a fixed size, so this approach does not involve containers of variable size containing measurements. Furthermore, one may save a new measurement

For example, each voxel may be considered as a multidimensional (e.g., across multiple properties) one-pole/moving average filter. This may advantageously preempt the need to store additional state beyond the voxel's associated set of properties. In some embodiments, the properties associated with the voxel include a “last updated” metadata; the last updated metadata (e.g., a time stamp of a previous measurement) allows a temporal distance to a previous measurement. The last updated metadata may be used to support replaying of measurement history for a voxel, as described herein. When a measurement is obtained, the coefficients of the filter (e.g., weighting of the old properties vs. the new measurement properties) may be determined based on physical distance (e.g., distance from a measurement position to a voxel position, scaled based on the distance weight described herein), temporal distance (e.g., time since a previous measurement caused a voxel to be updated, a measurement close in time receive near equal weight, a measurement occurring later after a previous measurement receive a higher weight (e.g., a new measurement obtained a year later would replace a previous measurement), a first measurement receives full weight), and/or confidence (e.g., higher confidence measurements (e.g., absolute value, relative to a confidence value of a voxel) receive higher weight).

By perceptually matching responses of AR, MR, or XR sources with an audio response of an environment (e.g., environmental reverb/reflection, acoustic environment fingerprint), the disclosed methods and systems allow virtual and real elements to blend indistinguishably to create a more immersive AR, MR, or XR experience for a user. By mapping the audio response of an environment, virtual and real audio sources would exhibit similar reverberation properties within a same physical space, reducing perceptual dissonances and increasing aural immersion for the user of the AR, MR, or XR environment.

For example, by using the disclosed methods and systems to generate an environmental mapping, a user's voice and virtual characters in the environment would exhibit similar reverberation properties. That is, the audio responses (e.g., reverberation) of the user's voice and the sound from the virtual characters would match, and the virtual characters would appear to exist in a same space as a listener.

In some embodiments, a wearable head device (e.g., a wearable head device described herein, an AR, MR, or XR system described herein) includes: a processor; a memory; and a program stored in the memory, configured to be executed by the processor, and including instructions for performing the methods described with respect to FIGS. 6-8.

In some embodiments, a non-transitory computer readable storage medium stores one or more programs, and the one or more programs includes instructions. When the instructions are executed by an electronic device (e.g., an electronic device or system described herein) with one or more processors and memory, the instructions cause the electronic device to perform the methods described with respect to FIGS. 6-8.

Although examples of the disclosure are described with respect to a wearable head device or an AR, MR, or XR system, it is understood that the disclosed environmental mapping methods may also be performed using other devices or systems. For example, the disclosed methods may be performed using a mobile device to determine and map audio responses of an environment (e.g., an AR, MR, or XR environment).

Although examples of the disclosure are described with respect to reverberation, it is understood that the disclosed environmental mapping methods may also be performed generally for other audio parameters of an AR, MR, or XR environment. For example, the disclosed methods may be performed to determine echo responses of the AR, MR, or XR environment.

With respect to the systems and methods described herein, elements of the systems and methods can be implemented by one or more computer processors (e.g., CPUs or DSPs) as appropriate. The disclosure is not limited to any particular configuration of computer hardware, including computer processors, used to implement these elements. In some cases, multiple computer systems can be employed to implement the systems and methods described herein. For example, a first computer processor (e.g., a processor of a wearable device coupled to one or more microphones) can be utilized to receive input microphone signals, and perform initial processing of those signals. A second (and perhaps more computationally powerful) processor can then be utilized to perform more computationally intensive processing. Another computer device, such as a cloud server, can host an audio processing engine, to which input signals are ultimately provided. Other suitable configurations will be apparent and are within the scope of the disclosure.

According to some embodiments, a method comprises: receiving a signal; and determining whether the signal meets a requirement of an analysis.

According to some embodiments, the signal comprises an audio signal, and the analysis is associated with an audio mapping of an environment.

According to some embodiments, the requirement comprises at least one of minimum signal-to-noise (SNR) constraint, signal duration constraint, collocation constraint, omnidirectional constraint, and impulsive signal constraint.

According to some embodiments, determining whether the minimum SNR constraint is met comprises determining whether a signal level exceeds a threshold value.

According to some embodiments, the threshold value is a second threshold value above the noise floor.

According to some embodiments, the method further comprises tracking the noise floor.

According to some embodiments, the method further comprises adjusting the noise floor.

According to some embodiments, determining whether the duration constraint is met comprises determining whether a signal level exceeds a threshold value for at least a threshold duration of time.

According to some embodiments, determining whether the collocation constraint is met comprises determining whether a source of the signal is within a threshold distance of a location of the receipt of the signal.

According to some embodiments, determining whether the collocation constraint is met comprises applying a VAD process based on the signal.

According to some embodiments, determining whether the omnidirectional constraint is met comprises determining whether a source of the signal comprises an omnidirectional source.

According to some embodiments, determining whether the omnidirectional constraint is met comprises determining one or more of a radiation pattern for a source of the signal and an orientation for the source of the signal.

According to some embodiments, determining whether the omnidirectional constraint is met comprises applying a VAD process based on the signal.

According to some embodiments, determining whether the impulse constraint is met comprises determining whether the signal comprises an instantaneous, impulsive, or transient signal.

According to some embodiments, determining whether the impulse constraint is met comprises applying a dual envelope follower based on the signal.

According to some embodiments, the method further comprises: determining the impulse constraint is not met; and in accordance with the determination that the impulse constraint is not met: converting the signal into a clean input stream; and comparing the clean input stream with the signal.

According to some embodiments, the method further comprises: in accordance with a determination that the analysis requirement is met, performing a below method; and in accordance with a determination that the analysis requirement is not met, forgoing performing a below method.

According to some embodiments, the method further comprises smoothing the signal into an RMS envelope.

According to some embodiments, the method further comprises line-fitting the RMS envelope.

According to some embodiments, the signal comprises a block of samples.

According to some embodiments, receiving the signal further comprises detecting the signal via a microphone.

According to some embodiments, receiving the signal further comprises receiving the signal from a storage.

According to some embodiments, the signal is generated by a user.

According to some embodiments, the signal is generated orally by the user.

According to some embodiments, the signal is generated non-orally by the user.

According to some embodiments, the signal is generated by a device different than a device receiving the signal.

According to some embodiments, the method further comprises requesting generation of the signal, wherein the signal generated in response to a request to generate the signal.

According to some embodiments, a method comprises: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

According to some embodiments, the signal meets an analysis requirement.

According to some embodiments, the analysis requirement is at least one of minimum signal-to-noise (SNR) constraint, signal duration constraint, collocation constraint, omnidirectional constraint, and impulsive signal constraint.

According to some embodiments, the method further comprises smoothing the signal using an RMS envelope.

According to some embodiments, filtering the signal comprises using a FIR non-causal, zero-phase filter.

According to some embodiments, filtering the signal comprises using a FIR non-causal quadrature mirror filter (QMF).

According to some embodiments, the sub-bands comprises a low frequency sub-band, a mid frequency sub-band, and a high frequency sub-band.

According to some embodiments, a number of sub-bands is greater than a number of decay time control points.

According to some embodiments, identifying the peak of the signal comprises identifying a local minima of a first derivative of the signal.

According to some embodiments, the peak is temporally located before a time of the local minima.

According to some embodiments, identifying the peak of the signal comprises identifying a portion of a first derivative of the signal below a threshold value.

According to some embodiments, the peak is temporally located before a time of the portion of the first derivative of the signal below the threshold value.

According to some embodiments, identifying the decay comprises line-fitting a decaying portion of the signal corresponding to the sub-band.

According to some embodiments, the signal corresponding to the sub-band comprises an early reflection portion between the peak and the decay portion.

According to some embodiments, the early reflection portion comprises a portion of the signal corresponding to early reflections.

According to some embodiments, the method further comprises from the early reflection portion: determining a reflection delay; and determining a reflection gain.

According to some embodiments, an end of the decaying portion corresponds to a threshold signal level.

According to some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

According to some embodiments, the decay times and reverberation gains are combined by line-fitting.

According to some embodiments, the decay times and reverberation gains are combined based on weights corresponding to the respective decay times and reverberation gains.

According to some embodiments, the method further comprises repeating the method.

According to some embodiments, a method comprises: receiving a signal; generating a direct path signal; deconvolving the signal based on the direct path signal; based on said deconvolving: determining a decay time; and determining a reverberation gain.

According to some embodiments, a method comprises associating one or more portions of an audio mapping of an environment to a plurality of voxels located in the environment. Each portion comprises an audio response property associated with a location of a respective voxel in the environment.

According to some embodiments, the method further comprises: determining a location of a device, a first voxel of the plurality of voxels comprising the location of the device; and presenting, to the device, a sound of the environment based on an audio response property associated with the first voxel.

According to some embodiments, the audio response property comprises at least one of reverberation gain, decay time, reflection delay, and reflection gain.

According to some embodiments, volumes of the voxels are uniform.

According to some embodiments, volumes of the voxels are non-uniform.

According to some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

According to some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

According to some embodiments, the weight is based on a distance between the first voxel and a location of the first signal.

According to some embodiments, the weight is based on an age of the audio response property associated with the first voxel.

According to some embodiments, the weight is based on a determination of whether the first voxel is associated with a second audio response property, prior to association of the first audio response property.

According to some embodiments, the weight is based on a confidence of the audio response property associated with the first voxel.

According to some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

According to some embodiments, the method further comprises: receiving the first signal at a first time; and receiving the second signal at a second time.

According to some embodiments, the method further comprises: receiving, at a first device, the first signal; and receiving, at a second device, the second signal.

According to some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

According to some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

According to some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain.

According to some embodiments, the plurality of voxels are associated with metadata, wherein the metadata comprises at least one of first measurement, time stamp, position, and confidence.

According to some embodiments, a system comprises: a microphone; and one or more processors configured to execute a method comprising: receiving, via the microphone, a signal; and determining whether the signal meets a requirement of an analysis.

According to some embodiments, the signal comprises an audio signal, and the analysis is associated with an audio mapping of an environment.

According to some embodiments, the requirement comprises at least one of minimum signal-to-noise (SNR) constraint, signal duration constraint, collocation constraint, omnidirectional constraint, and impulsive signal constraint.

According to some embodiments, determining whether the minimum SNR constraint is met comprises determining whether a signal level exceeds a threshold value.

According to some embodiments, the threshold value is a second threshold value above the noise floor.

According to some embodiments, the method further comprises tracking the noise floor.

According to some embodiments, the method further comprises adjusting the noise floor.

According to some embodiments, determining whether the duration constraint is met comprises determining whether a signal level exceeds a threshold value for at least a threshold duration of time.

According to some embodiments, determining whether the collocation constraint is met comprises determining whether a source of the signal is within a threshold distance of a location of the receipt of the signal.

According to some embodiments, determining whether the collocation constraint is met comprises applying a VAD based on the signal.

According to some embodiments, determining whether the omnidirectional constraint is met comprises determining whether a source of the signal comprises an omnidirectional source.

According to some embodiments, determining whether the omnidirectional constraint is met comprises determining one of more of a radiation pattern for a source of the signal and an orientation for the source of the signal.

According to some embodiments, determining whether the omnidirectional constraint is met comprises applying a VAD process based on the signal.

According to some embodiments, determining whether the impulse constraint is met comprises determining whether the signal comprises one or more of an instantaneous signal, an impulse signal, and a transient signal.

According to some embodiments, determining whether the impulse constraint is met comprises applying a dual envelope follower based on the signal.

According to some embodiments, the method further comprises: determining the impulse constraint is not met; and in accordance with the determination that the impulse constraint is not met: converting the signal into a clean input stream; and comparing the clean input stream with the signal.

According to some embodiments, wherein the method further comprises: in accordance with a determination that the analysis requirement is met, performing an above method; and in accordance with a determination that the analysis requirement is not met, forgoing performing an above method.

According to some embodiments, the method further comprises smoothing the signal into an RMS envelope.

According to some embodiments, the method further comprises line-fitting the RMS envelope.

According to some embodiments, the signal comprises a block of samples.

According to some embodiments, receiving the signal further comprises detecting the signal via a microphone.

According to some embodiments, receiving the signal further comprises receiving the signal from a storage.

According to some embodiments, the signal is generated by a user.

According to some embodiments, the signal is generated orally by the user.

According to some embodiments, the signal is generated non-orally by the user.

According to some embodiments, the signal is generated by a device different than a device receiving the signal.

According to some embodiments, the method further comprises requesting generation of the signal, wherein the signal generated in response to a request to generate the signal.

According to some embodiments, the system further comprises a wearable head device, wherein the wearable head device comprises the microphone.

According to some embodiments, a system comprises one or more processors configured to execute a method comprising: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

According to some embodiments, the signal meets an analysis requirement.

According to some embodiments, the analysis requirement is at least one of minimum signal-to-noise (SNR) constraint, signal duration constraint, collocation constraint, omnidirectional constraint, and impulsive signal constraint.

According to some embodiments, the method further comprises smoothing the signal using an RMS envelope.

According to some embodiments, filtering the signal comprises using a FIR non-causal, zero-phase filter.

According to some embodiments, filtering the signal comprises using a FIR non-causal quadrature mirror filter (QMF).

According to some embodiments, the sub-bands comprises a low frequency sub-band, a mid frequency sub-band, and a high frequency sub-band.

According to some embodiments, a number of sub-bands is greater than a number of decay time control points.

According to some embodiments, identifying the peak of the signal comprises identifying a local minima of a first derivative of the signal.

According to some embodiments, the peak is temporally located before a time of the local minima.

According to some embodiments, identifying the peak of the signal comprises identifying a portion of a first derivative of the signal below a threshold value.

According to some embodiments, the peak is temporally located before a time of the portion of the first derivative of the signal below the threshold value.

According to some embodiments, identifying the decay comprises line-fitting a decaying portion of the signal corresponding to the sub-band.

According to some embodiments, the signal corresponding to the sub-band comprises an early reflection portion between the peak and the decay portion.

According to some embodiments, the early reflection portion comprises a portion of the signal corresponding to early reflections.

According to some embodiments, the method further comprises from the early reflection portion: determining a reflection delay; and determining a reflection gain.

According to some embodiments, an end of the decaying portion corresponds to a threshold signal level.

According to some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

According to some embodiments, the decay times and reverberation gains are combined by line-fitting.

According to some embodiments, the decay times and reverberation gains are combined based on weights corresponding to the respective decay times and reverberation gains.

According to some embodiments, the method further comprises repeating the method periodically.

According to some embodiments, the system further comprises a server, wherein the server comprises at least one of the one or more processors.

According to some embodiments, the system further comprises a wearable head device, wherein the wearable head device comprises at least one of the one or more processors.

According to some embodiments, a system comprises one or more processors configured to execute a method comprising: receiving a signal; generating a direct path signal; deconvolving the signal based on the direct path signal; based on said deconvolving: determining a decay time; and determining a reverberation gain.

According to some embodiments, the system further comprises a server, wherein the server comprises at least one of the one or more processors.

According to some embodiments, the system further comprises a wearable head device, wherein the wearable head device comprises at least one of the one or more processors.

According to some embodiments, a system comprises one or more processors configured to execute a method comprising associating one or more portions of an audio mapping of an environment to a plurality of voxels located in the environment. Each portion comprises an audio response property associated with a location of a respective voxel in the environment.

According to some embodiments, the method further comprises: determining a location of a device, a first voxel of the plurality of voxels comprising the location of the device; and presenting, to the device, a sound of the environment based on an audio response property associated with the first voxel.

According to some embodiments, the audio response property comprises at least one of reverberation gain, decay time, reflection delay, and reflection gain.

According to some embodiments, volumes of the voxels are uniform.

According to some embodiments, volumes of the voxels are non-uniform.

According to some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

According to some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

According to some embodiments, the weight is based on a distance between the first voxel and a location of the first signal.

According to some embodiments, the weight is based on an age of the audio response property associated with the first voxel.

According to some embodiments, the weight is based on a determination of whether the first voxel is associated with a second audio response property, prior to association of the first audio response property.

According to some embodiments, the weight is based on a confidence of the audio response property associated with the first voxel.

According to some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

According to some embodiments, the method further comprises: receiving the first signal at a first time; and receiving the second signal at a second time.

According to some embodiments, the method further comprises: receiving, at a first device, the first signal; and receiving, at a second device, the second signal.

According to some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

According to some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

According to some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain.

According to some embodiments, the plurality of voxels are associated with metadata, wherein the metadata comprises at least one of first measurement, time stamp, position, and confidence.

According to some embodiments, the system further comprises a server, wherein the server comprises at least one of the one or more processors.

According to some embodiments, the system further comprises a wearable head device, wherein the wearable head device comprises at least one of the one or more processors.

According to some embodiments, a non-transitory computer-readable medium stores one or more instructions, which, when executed by one or more processors of an electronic device, cause the device to perform a method comprising: receiving a signal; and determining whether the signal meets a requirement of an analysis.

According to some embodiments, the signal comprises an audio signal, and the analysis is associated with an audio mapping of an environment.

According to some embodiments, the requirement comprises at least one of minimum signal-to-noise (SNR) constraint, signal duration constraint, collocation constraint, omnidirectional constraint, and impulsive signal constraint.

According to some embodiments, determining whether the minimum SNR constraint is met comprises determining whether a signal level exceeds a threshold value.

According to some embodiments, the threshold value is a second threshold value above the noise floor.

According to some embodiments, the method further comprises tracking the noise floor.

According to some embodiments, the method further comprises adjusting the noise floor.

According to some embodiments, determining whether the duration constraint is met comprises determining whether a signal level exceeds a threshold value for at least a threshold duration of time.

According to some embodiments, determining whether the collocation constraint is met comprises determining whether a source of the signal is within a threshold distance of a location of the receipt of the signal.

According to some embodiments, determining whether the collocation constraint is met comprises applying a VAD process based on the signal.

According to some embodiments, determining whether the omnidirectional constraint is met comprises determining whether a source of the signal comprises an omnidirectional source.

According to some embodiments, determining whether the omnidirectional constraint is met comprises determining one or more of a radiation pattern for a source of the signal and an orientation for the source of the signal.

According to some embodiments, determining whether the omnidirectional constraint is met comprises applying a VAD process based on the signal.

According to some embodiments, determining whether the impulse constraint is met comprises determining whether the signal comprises one or more of an instantaneous signal, an impulse signal, and a transient signal.

According to some embodiments, determining whether the impulse constraint is met comprises applying a dual envelope follower based on the signal.

According to some embodiments, the method further comprises: determining the impulse constraint is not met; and in accordance with the determination that the impulse constraint is not met: converting the signal into a clean input stream; and comparing the clean input stream with the signal.

According to some embodiments, the method further comprises in accordance with a determination that the analysis requirement is met, performing an above method; and in accordance with a determination that the analysis requirement is not met, forgoing performing an above method.

According to some embodiments, the method further comprises smoothing the signal into an RMS envelope.

According to some embodiments, wherein the method further comprises line-fitting the RMS envelope.

According to some embodiments, the signal comprises a block of samples.

According to some embodiments, receiving the signal further comprises detecting the signal via a microphone.

According to some embodiments, receiving the signal further comprises receiving the signal from a storage.

According to some embodiments, the signal is generated by a user.

According to some embodiments, the signal is generated orally by the user.

According to some embodiments, the signal is generated non-orally by the user.

According to some embodiments, the signal is generated by a device different than a device receiving the signal.

According to some embodiments, the method further comprises requesting generation of the signal, wherein the signal generated in response to a request to generate the signal.

According to some embodiments, a non-transitory computer-readable medium stores one or more instructions, which, when executed by one or more processors of an electronic device, cause the device to perform a method comprising: receiving a signal; filtering the signal, wherein filtering the signal comprises separating the signal into a plurality of sub-bands; and for a sub-band of the sub-bands: identifying a peak of the signal; identifying a decay of the signal; based on the peak, the decay, or both the peak and the decay: determining a decay time; and determining a reverberation gain.

According to some embodiments, the signal meets an analysis requirement.

According to some embodiments, the analysis requirement is at least one of minimum signal-to-noise (SNR) constraint, signal duration constraint, collocation constraint, omnidirectional constraint, and impulsive signal constraint.

According to some embodiments, the method further comprises smoothing the signal using an RMS envelope.

According to some embodiments, filtering the signal comprises using a FIR non-causal, zero-phase filter.

According to some embodiments, filtering the signal comprises using a FIR non-causal quadrature mirror filter (QMF).

According to some embodiments, the sub-bands comprises a low frequency sub-band, a mid frequency sub-band, and a high frequency sub-band.

According to some embodiments, a number of sub-bands is greater than a number of decay time control points.

According to some embodiments, identifying the peak of the signal comprises identifying a local minima of a first derivative of the signal.

According to some embodiments, the peak is temporally located before a time of the local minima.

According to some embodiments, identifying the peak of the signal comprises identifying a portion of a first derivative of the signal below a threshold value.

According to some embodiments, the peak is temporally located before a time of the portion of the first derivative of the signal below the threshold value.

According to some embodiments, identifying the decay comprises line-fitting a decaying portion of the signal corresponding to the sub-band.

According to some embodiments, the signal corresponding to the sub-band comprises an early reflection portion between the peak and the decay portion.

According to some embodiments, the early reflection portion comprises a portion of the signal corresponding to early reflections.

According to some embodiments, the method further comprises, from the early reflection portion: determining a reflection delay; and determining a reflection gain.

According to some embodiments, an end of the decaying portion corresponds to a threshold signal level.

According to some embodiments, the method further comprises: for a second sub-band of the sub-bands: identifying a second peak of the signal; identifying a second decay of the signal; based on the second peak, the second decay, or both the second peak and the second decay: determine a second decay time; and determine a second reverberation gain; combining the first and second decay times; and combining the first and second reverberation gain.

According to some embodiments, the decay times and reverberation gains are combined by line-fitting.

According to some embodiments, the decay times and reverberation gains are combined based on weights corresponding to the respective decay times and reverberation gains.

According to some embodiments, the method further comprises repeating the method of claim 166 periodically.

According to some embodiments, a non-transitory computer-readable medium stores one or more instructions, which, when executed by one or more processors of an electronic device, cause the device to perform a method comprising: receiving a signal; generating a direct path signal; deconvolving the signal based on the direct path signal; based on said deconvolving: determining a decay time; and determining a reverberation gain.

According to some embodiments, a non-transitory computer-readable medium stores one or more instructions, which, when executed by one or more processors of an electronic device, cause the device to perform a method comprising associating one or more portions of an audio mapping of an environment to a plurality of voxels located in the environment. Each portion comprises an audio response property associated with a location of a respective voxel in the environment.

According to some embodiments, the method further comprises: determining a location of a device, a first voxel of the plurality of voxels comprising the location of the device; and presenting, to the device, a sound of the environment based on an audio response property associated with the first voxel.

According to some embodiments, the audio response property comprises at least one of reverberation gain, decay time, reflection delay, and reflection gain.

According to some embodiments, volumes of the voxels are uniform.

According to some embodiments, volumes of the voxels are non-uniform.

According to some embodiments, the method further comprises determining at least one of a reverberation gain, a decay time, a reflection time, and a reflection gain based on a first signal, wherein the audio response property associated with a first voxel of the plurality of voxels comprises at least one of the reverberation gain, the decay time, the reflection time, and the reflection gain.

According to some embodiments, the method further comprises determining a weight corresponding to the reverberation gain, the decay time, the reflection time, or the reflection gain, wherein the audio response property associated with the first voxel is based on at least one of the weighted reverberation gain, the weighted decay time, the weighted reflection time, and the weighted reflection gain.

According to some embodiments, the weight is based on a distance between the first voxel and a location of the first signal.

According to some embodiments, the weight is based on an age of the audio response property associated with the first voxel.

According to some embodiments, the weight is based on a determination of whether the first voxel is associated with a second audio response property, prior to association of the first audio response property.

According to some embodiments, the weight is based on a confidence of the audio response property associated with the first voxel.

According to some embodiments, the method further comprises determining at least one of a second reverberation gain, a second decay time, a second reflection time, and a second reflection gain based on a second signal, wherein the audio response property associated with the voxel is further based on at least one of the second reverberation gain, the second decay time, the second reflection time, and the second reflection gain.

According to some embodiments, the method further comprises: receiving the first signal at a first time; and receiving the second signal at a second time.

According to some embodiments, the method further comprises: receiving, at a first device, the first signal; and receiving, at a second device, the second signal.

According to some embodiments, the method further comprises: determining whether a number of audio response properties associated with the first voxel is below a threshold value; in accordance with a determination that the number of audio response properties associated with the first voxel is below the threshold value, determining at least one of a second reverberation gain, a second decay time, a reflection time, and a reflection gain based on a second signal; and in accordance with a determination that the number of voxel properties associated with the first voxel is not below the threshold value, forgoing determining the second reverberation gain, the second decay time, the reflection time, and the reflection gain.

According to some embodiments, the method further comprises: determining at least one of a second reverberation gain, a second decay time, a reflection time, and a reflection gain based on a second signal; determining whether a location of the second signal is within a maximum distance associated with the first voxel; in accordance with a determination that the location of the second signal is within a maximum distance of the first voxel, updating the audio response property associated with the first voxel based on at least one of the second reverberation gain, the second decay time, the reflection time, and the reflection gain; and in accordance with a determination that the location of the second signal is not within the maximum distance associated with the first voxel, forgoing updating the audio response property associated with the first voxel based on the second reverberation gain, the second decay time, the reflection time, and the reflection gain.

According to some embodiments, a second voxel of the plurality of voxels is associated with a second audio response property, the method further comprising: determining a first weight and a second weight corresponding to at least one of the reverberation gain, the decay time, the reflection time, and the reflection gain, wherein: the first audio response property is based on at least one of the first weighted reverberation gain, the first weighted decay time, the first weighted reflection time, and the first reflection gain, and the second audio response property based on at least the second weighted reverberation gain, the second weighted decay time, the second weighted reflection time, and the second weighted reflection gain.

According to some embodiments, the plurality of voxels are associated with metadata, wherein the metadata comprises at least one of first measurement, time stamp, position, and confidence.

Although the disclosed examples have been fully described with reference to the accompanying drawings, it is to be noted that various changes and modifications will become apparent to those skilled in the art. For example, elements of one or more implementations may be combined, deleted, modified, or supplemented to form further implementations. Such changes and modifications are to be understood as being included within the scope of the disclosed examples as defined by the appended claims.

What is claimed is:

1. A method comprising:
receiving an audio signal;
determining whether the audio signal meets a requirement for an audio mapping of an environment, wherein the requirement comprises at least one of a minimum signal-to-noise (SNR) constraint, a signal duration constraint, a collocation constraint, an omnidirectional constraint, and an impulsive signal constraint;
in accordance with a determination that the requirement is met, performing said audio mapping; and
in accordance with a determination that the requirement is not met, forgoing performing said audio mapping.

2. The method of claim 1, wherein the determining whether the minimum SNR constraint is met comprises determining whether a signal level exceeds a threshold value.

3. The method of claim 1, wherein the determining whether the signal duration constraint is met comprises determining whether a signal level exceeds a threshold value for at least a threshold duration of time.

4. The method of claim 1, wherein the determining whether the collocation constraint is met comprises:
determining whether a source of the signal is within a threshold distance of a location of the receipt of the signal.

5. The method of claim 1, wherein the determining whether the collocation constraint is met comprises applying a voice activated detection (VAD) process based on the signal.

6. The method of claim 1, wherein the determining whether the omnidirectional constraint is met comprises determining whether a source of the signal comprises an omnidirectional source.

7. The method of claim 1, wherein the determining whether the omnidirectional constraint is met comprises determining one or more of a radiation pattern for a source of the signal and an orientation for the source of the signal.

8. The method of claim 1, wherein the determining whether the omnidirectional constraint is met comprises applying a VAD process based on the signal.

9. The method of claim 1, wherein the determining the impulse constraint is met comprises determining whether the signal comprises one or more of an instantaneous signal, an impulse signal, and a transient signal.

10. The method of claim 1, wherein the determining whether the impulse constraint is met comprises applying a dual envelope follower based on the signal.

11. The method of claim 1, further comprising:
determining the impulse constraint is not met; and
in accordance with the determination that the impulse constraint is not met:
converting the signal into a clean input stream; and
comparing the clean input stream with the signal.

12. A method comprising:
receiving a signal;
filtering the signal, wherein filtering the signal comprises separating the signal into a plurality of sub-bands; and
for a sub-band of the sub-bands:
identifying a peak of the signal;
identifying a decay of the signal;
based on the peak, the decay, or both the peak and the decay:
determining a decay time; and
determining a reverberation gain.

13. A method comprising:
receiving a signal;
generating a direct path signal;
deconvolving the signal based on the direct path signal;
based on said deconvolving:
determining a decay time; and
determining a reverberation gain.

14. A method comprising: associating one or more portions of an audio mapping of an environment to a plurality of voxels located in the environment, wherein:
each portion comprises an audio response property associated with a location of a respective voxel in the environment.

15. A system comprising: one or more processors configured to perform a method comprising:
receiving an audio signal;
determining whether the audio signal meets a requirement for an audio mapping of an environment, wherein the requirement comprises at least one of a minimum signal-to-noise (SNR) constraint, a signal duration constraint, a collocation constraint, an omnidirectional constraint, and an impulsive signal constraint;
in accordance with a determination that the requirement is met, performing said audio mapping; and
in accordance with a determination that the requirement is not met, forgoing performing said audio mapping.

16. A non-transitory computer-readable medium storing one or more instructions, which, when executed by one or more processors of an electronic device, cause the device to perform a method comprising:
receiving an audio signal;
determining whether the audio signal meets a requirement for an audio mapping of an environment, wherein the requirement comprises at least one of a minimum signal-to-noise (SNR) constraint, a signal duration constraint, a collocation constraint, an omnidirectional constraint, and an impulsive signal constraint;
in accordance with a determination that the requirement is met, performing said audio mapping; and
in accordance with a determination that the requirement is not met, forgoing performing said audio mapping.

17. The system of claim 15, wherein the determining whether the minimum SNR constraint is met comprises determining whether a signal level exceeds a threshold value.

18. The system of claim 15, wherein the determining whether the signal duration constraint is met comprises determining whether a signal level exceeds a threshold value for at least a threshold duration of time.

19. The system of claim 15, wherein the determining whether the collocation constraint is met comprises:
determining whether a source of the signal is within a threshold distance of a location of the receipt of the signal.

20. The system of claim 15, wherein the determining whether the collocation constraint is met comprises applying a voice activated detection (VAD) process based on the signal.
